(19) United States
(12) Patent Application Publication
(10) Pub. No.: US 2022/0350064 A1
(43) Pub. Date: Nov. 3, 2022

(54) THIN FILM LAMINATES HAVING CONTROLLED STRAIN

(71) Applicant: META PLATFORMS TECHNOLOGIES, LLC, Menlo Park, CA (US)

(72) Inventors: Andrew John Ouderkirk, Kirkland, WA (US); Nagi Hosni Elabbasi, Southborough, MA (US); Sheng Ye, Redmond, WA (US); Christopher Yuan Ting Liao, Seattle, WA (US); Hannah Noble, Sunnyvale, CA (US)

(21) Appl. No.: 17/488,865

(22) Filed: Sep. 29, 2021

Related U.S. Application Data
(60) Provisional application No. 63/181,012, filed on Apr. 28, 2021.
(60) Provisional application No. 63/181,260, filed on Apr. 29, 2021.

(51) Int. Cl. G02B 5/30; G02B 1/04; B32B 1/00; B32B 27/08; B32B 7/023; B32B 27/32; B32B 27/30

(52) U.S. Cl. CPC G02B 5/305; G02B 1/04; B32B 1/00; B32B 27/08; B32B 7/023; B32B 27/32; B32B 27/304; B32B 2307/412; B32B 2250/02; B32B 2250/246; B32B 2551/00

(57) ABSTRACT

An optically or mechanically anisotropic polymer thin film is characterized by compound curvature, where a maximum variation of an angle of orientation of an extraordinary axis of the polymer thin film is at most 2% greater than an orientation variation associated with an initially planar polymer thin film formed to the same compound curvature.

### CROSS-REFERENCE TO RELATED APPLICATIONS

This application claims the benefit of priority under 35 U.S.C. § 119(e) of U.S. Provisional Application No. 63/181,012, filed Apr. 28, 2021, and U.S. Provisional Application No. 63/181,260, filed Apr. 29, 2021, the contents of which are incorporated herein by reference in their entirety.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 illustrates an example method for stretching a polymer thin film over a curved backing layer having a lens geometry according to some embodiments.

FIG. 2 shows the effect of deformation on the orientation of the polymer thin film of FIG. 1 according to some embodiments.

FIG. 3 is a series of contour plots showing the optical power of the stretched polymer thin film of FIG. 1 according to certain embodiments.

FIG. 4 shows the optical power and stress profile for the stretched polymer thin film of FIG. 1 according to some embodiments.

FIG. 5 illustrates the progression of the stress profile for the polymer thin film of FIG. 1 during the act of stretching the polymer thin film according to some embodiments.

FIG. 6 illustrates representative strain profiles for the polymer thin film of FIG. 1 following the act of stretching according to certain embodiments.

FIG. 7 illustrates representative strain profiles for the polymer thin film of FIG. 1 following removal of the backing layer from the polymer thin film according to certain embodiments.

FIG. 8 shows contour plots of the strains in the stretched polymer thin film of FIG. 1 following removal of the frame supporting the backing layer according to some embodiments.

FIG. 9 shows strain profiles within the stretched polymer thin film of FIG. 1 following removal of the frame holding the backing layer according to some embodiments.

FIG. 10 illustrates an example method for stretching a planar anisotropic polymer thin film over a backing layer having a constant spherical curvature according to some embodiments.

FIG. 11 is a series of contour plots showing the uniformity in optical power of the stretched polymer thin film of FIG. 10 according to certain embodiments.

FIG. 12 shows the optical power and stress profile for the stretched polymer thin film of FIG. 10 following removal of the backing layer from the polymer thin film according to some embodiments.

FIG. 13 illustrates the progression of the stress profile for the polymer thin film of FIG. 10 during the act of stretching according to some embodiments.

FIG. 14 illustrates representative strain profiles for the polymer thin film of FIG. 10 following the act of stretching according to certain embodiments.

FIG. 15 illustrates representative strain profiles for the polymer thin film of FIG. 10 following removal of the frame holding the backing layer according to certain embodiments.

FIG. 16 shows strain profiles within the stretched polymer thin film of FIG. 10 following removal of the backing layer according to some embodiments.

FIG. 17 shows strain profiles within the stretched polymer thin film of FIG. 10 following removal of the frame holding the backing layer according to some embodiments.

FIG. 18 shows contour plots of the stresses within a lens independent of the stretched polymer thin film of FIG. 10 following removal of the frame holding the backing layer according to some embodiments.

FIG. 19 illustrates an example method for stretching a polymer thin film having y-axis oriented cylindrical curvature over a backing layer having constant spherical curvature according to some embodiments.

FIG. 20 is a series of contour plots showing the optical power of the stretched polymer thin film of FIG. 19 according to certain embodiments.

FIG. 21 shows the optical power and stress profile for the stretched polymer thin film of FIG. 19 according to some embodiments.

FIG. 22 illustrates the progression of the stress profile for the polymer thin film of FIG. 19 during the act of stretching according to some embodiments.

FIG. 23 illustrates representative strain profiles for the polymer thin film of FIG. 19 following the act of stretching according to certain embodiments.

FIG. 24 illustrates representative strain profiles for the polymer thin film of FIG. 19 following removal of the frame holding the backing layer according to certain embodiments.

FIG. 25 shows contour plots of the strains in the stretched polymer thin film of FIG. 19 following removal of the frame holding the backing layer according to some embodiments.

FIG. 26 shows strain profiles within the stretched polymer thin film of FIG. 19 following removal of the frame holding the backing layer according to some embodiments.

FIG. 27 illustrates an example method for stretching a polymer thin film having x-axis oriented cylindrical curvature over a backing layer having constant spherical curvature according to some embodiments.

FIG. 28 is a series of contour plots showing the optical power of the stretched polymer thin film of FIG. 27 according to certain embodiments.

FIG. 29 shows the optical power and stress profile for the stretched polymer thin film of FIG. 27 following removal of the backing layer according to some embodiments.

FIG. 30 illustrates the progression of the stress profile for the polymer thin film of FIG. 27 during the act of stretching according to some embodiments.

FIG. 31 illustrates representative strain profiles for the polymer thin film of FIG. 27 following the act of stretching according to certain embodiments.

FIG. 32 illustrates representative strain profiles for the polymer thin film of FIG. 27 following removal of the backing layer from the polymer thin film according to certain embodiments.

FIG. 33 shows contour plots of the strains in the stretched polymer thin film of FIG. 27 following removal of the frame holding the backing layer according to some embodiments.

FIG. 34 shows strain profiles within the stretched polymer thin film of FIG. 27 following removal of the frame holding the backing layer according to some embodiments.

FIG. 35 illustrates an example method for stretching a planar and mechanically anisotropic polymer thin film over a backing layer having constant spherical curvature according to some embodiments.

FIG. 36 shows the optical power and stress profile for the stretched polymer thin film of FIG. 35 according to some embodiments.

FIG. 37 illustrates representative strain profiles for the polymer thin film of FIG. 35 following removal of the frame holding the backing layer according to certain embodiments.

FIG. 38 shows contour plots of the strains in the stretched polymer thin film of FIG. 35 following removal of the frame holding the backing layer according to some embodiments.

FIG. 39 shows the orientation of the stretched polymer thin film of FIG. 35 following removal of the frame holding the backing layer according to certain embodiments.

FIG. 40 illustrates an example method for stretching a mechanically anisotropic polymer thin film having x-axis oriented cylindrical curvature over a backing layer having constant spherical curvature according to some embodiments.

FIG. 41 shows the optical power and stress profile for the stretched polymer thin film of FIG. 40 following removal of the frame supporting the backing layer according to some embodiments.

FIG. 42 illustrates representative strain profiles for the polymer thin film of FIG. 40 following removal of the frame holding the backing layer according to certain embodiments.

FIG. 43 shows contour plots of the strains in the stretched polymer thin film of FIG. 40 following removal of the frame holding the backing layer according to some embodiments.

FIG. 44 shows the orientation of the stretched polymer thin film of FIG. 40 following removal of the frame holding the backing layer according to certain embodiments.

FIG. 45 illustrates an example method for stretching an isotropic polymer thin film having a square footprint over a backing layer having constant spherical curvature according to some embodiments.

FIG. 46 shows contour plots of the normal strains in the stretched polymer thin film of FIG. 45 following removal of the frame supporting the backing layer according to some embodiments.

FIG. 47 shows contour plots of the radial and circumferential strains in the stretched polymer thin film of FIG. 45 following removal of the frame supporting the backing layer according to further embodiments.

FIG. 48 illustrates an example method for stretching a planar isotropic polymer thin film having a circular footprint over a backing layer having constant spherical curvature according to some embodiments.

FIG. 49 shows contour plots of the radial and circumferential strains in the stretched polymer thin film of FIG. 48 following removal of the frame supporting the backing layer according to some embodiments.

FIG. 50 illustrates an example method for stretching an isotropic polymer thin film having a cylindrical profile over a backing layer having constant spherical curvature according to some embodiments.

FIG. 51 illustrates representative strain profiles for the polymer thin film of FIG. 50 following removal of the frame holding the backing layer according to certain embodiments.

FIG. 52 shows contour plots of the strains in the stretched polymer thin film of FIG. 50 following removal of the frame supporting the backing layer according to some embodiments.

FIG. 53 shows the orientation of the stretched polymer thin film of FIG. 50 following removal of the frame holding the backing layer according to certain embodiments.

FIG. 54 shows the optical power and stress profile for the stretched polymer thin film of FIG. 50 following removal of the frame supporting the backing layer according to some embodiments.

FIG. 55 illustrates representative strain profiles for the polymer thin film of FIG. 50 following removal of the frame holding the backing layer according to certain embodiments.

FIG. 56 is a schematic illustration of a method for forming a polymer thin film laminate according to certain embodiments.

FIG. 57 illustrates an example method for stretching a planar isotropic polymer thin film laminate having a square profile over both sides of a backing layer having constant spherical curvature according to some embodiments.

FIG. 58 illustrates representative strain profiles for the polymer thin film laminate of FIG. 57 according to certain embodiments.

FIG. 59 shows the orientation of the stretched polymer thin film laminate of FIG. 57 following removal of the frame supporting the backing layer according to certain embodiments.

FIG. 60 shows contour plots that compare the optical power of a lens having a single polymer thin film disposed over the convex surface of the lens with the optical power of a lens including a polymer thin film disposed over each side of the lens according to some embodiments.

FIG. 61 shows contour plots that compare the optical cylindricity of a lens having a single polymer thin film disposed over the convex surface of the lens with the optical cylindricity of a lens including a polymer thin film disposed over each side of the lens according to some embodiments.

FIG. 62 shows contour plots of the stress profiles of a lens sandwiched between top and bottom polymer thin films independent of the polymer thin films following removal of the frame supporting the backing layer according to some embodiments.

FIG. 63 shows contour plots of the stress profiles of a lens independent of a polymer thin film disposed over a convex side of the lens following removal of the frame supporting the backing layer according to some embodiments.

FIG. 64 shows the through-thickness stress variation for (a) a lens disposed between top and bottom polymer thin films, and (b) a lens having a polymer thin film disposed over a single side of the lens according to various embodiments.

FIG. 65 illustrates an example method for stretching an anisotropic polymer thin film over a backing layer having constant spherical curvature according to some embodiments.

FIG. 66 illustrates representative strain profiles for the polymer thin film of FIG. 65 following removal of the frame holding the backing layer according to certain embodiments.

FIG. 67 shows the orientation of the stretched polymer thin film of FIG. 65 according to certain embodiments.

FIG. 68 shows contour plots of the stress profiles of a lens independent of a polymer thin film disposed over a convex side of the lens according to some embodiments.

FIG. 69 illustrates an example method for stretching an anisotropic polymer thin film having y-axis oriented cylindrical curvature over a backing layer having constant spherical curvature according to some embodiments.

FIG. 70 illustrates representative strain profiles for the polymer thin film of FIG. 69 following removal of the frame holding the backing layer according to certain embodiments.

FIG. 71 shows the orientation of the stretched polymer thin film of FIG. 69 according to certain embodiments.

FIG. 72 shows the orientation of the stretched polymer thin film of FIG. 69 according to certain embodiments.

FIG. 73 shows the orientation of the stretched polymer thin film of FIG. 69 according to further embodiments.

FIG. 74 shows the orientation of the stretched polymer thin film of FIG. 69 according to still further embodiments.

FIG. 75 is a schematic illustration of a multilayer polymer thin film laminate having a misoriented alignment of major and minor axes amongst the respective layers according to some embodiments.

FIG. 76 is an illustration of exemplary augmented-reality glasses that may be used in connection with embodiments of this disclosure.

FIG. 77 is an illustration of an exemplary virtual-reality headset that may be used in connection with embodiments of this disclosure.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

Polymer materials may be incorporated into a variety of different optic and electro-optic device architectures, including active and passive optics and electroactive devices. Lightweight and conformable, one or more polymer layers may be incorporated into wearable devices such as smart glasses and are attractive candidates for emerging technologies including virtual reality/augmented reality devices where a comfortable, adjustable form factor is desired.

Virtual reality (VR) and augmented reality (AR) eyewear devices or headsets, for instance, may enable users to experience events, such as interactions with people in a computer-generated simulation of a three-dimensional world or viewing data superimposed on a real-world view. By way of example, superimposing information onto a field of view may be achieved through an optical head-mounted display (OHMD) or by using embedded wireless glasses with a transparent heads-up display (HUD) or augmented reality (AR) overlay. VR/AR eyewear devices and headsets may be used for a variety of purposes. For example, governments may use such devices for military training, medical professionals may use such devices to simulate surgery, and engineers may use such devices as design visualization aids.

These and other applications may leverage one or more characteristics of thin film polymer materials, including piezoelectric properties to induce deformations and the refractive index to manipulate light. In various applications, optical elements and other components may include polymer thin films that have anisotropic mechanical or optical properties. During manufacture, the polymer thin films may be processed to form a compound curvature. As will be appreciated, the formation of a compound curve may cause undesired changes in the direction of anisotropic properties and induce strain in a polymer thin film. In some instances, and by way of example, excessive strain in uniaxially-oriented high and ultrahigh molecular weight polyethylene (HMWPE and UHMWPE) may cause internal fracture and micro-voiding, which may undesirably decrease optical clarity and increase haze. In further examples, the generation of compound curvature in multilayer reflective polarizers may create non-parallel polarization properties, which may decrease system contrast, for example, in pancake lenses.

Many optically and structurally anisotropic polymer layers are manufactured as initially planar thin films that are subsequently formed into a compound curvature for a particular application. An example system and method may include locating a planar polymer thin film over a substrate having compound curvature, constraining the polymer thin film with respect to an edge or a surface of the substrate, and applying a force to the polymer thin film, optionally while applying heat, to conformally apply the thin film to the surface of the substrate. The substrate may include a spherical surface of a lens, for example.

As will be appreciated, such a process may lead to undesirable changes in at least the direction of an extraordinary refractive index or high modulus axis of the polymer thin film over the newly-acquired contours. Also, the shaping process may create excessive strain in an ordinary axis of the thin film that can lead to undesirable optical and/or mechanical effects. As used herein, for a positive uniaxial material, the extraordinary axis is referred to as the slow axis, and the ordinary axis is referred to as the fast axis. Light polarized parallel to the fast axis travels at a higher velocity than light parallel to the orthogonal slow axis.

Notwithstanding recent developments, it would be advantageous to provide polymer thin films having improved anisotropic properties, including anisotropic properties that withstand shaping processes and the creation of compound curvature in the thin films. In accordance with various embodiments, disclosed herein are manufacturing processes for forming an optical element and more particularly manufacturing processes that can be configured to control the optical and/or mechanical axis and strain of a polymer thin film while shaping the polymer thin film into a compound curve.

According to some embodiments, various methods may include providing a polymer thin film, constraining the polymer thin film in a manner that induces a planar or non-planar shape in the polymer thin film during an act of applying a stress to the polymer thin film, and applying a templating element to the polymer thin film, where the templating element has a compound curvature and the compound curvature of the templating element has an extended geometry relative to the compound curvature formed in the polymer thin film.

As disclosed herein, an optical element, such as a lens system, may include a high or an ultra-high molecular weight polymer thin film. As used herein, a “high molecular weight polymer” may be characterized by long polymer chains and a molecular mass of approximately 100,000 amu to approximately 2 million amu, e.g., 100,000, 200,000, 500,000, 1,000,000 or 2,000,000 amu, including ranges between any of the foregoing values, whereas an “ultra-high molecular weight polymer” may be characterized by extremely long polymer chains and a molecular mass of at least approximately 2 million amu, e.g., 2, 4, 6, or 8 million amu, including ranges between any of the foregoing values.

In some embodiments, high and ultra-high molecular weight polymer thin films may be optically transparent and have at least one of a directionally dependent refractive index, a directionally dependent elastic modulus, a directionally dependent piezoelectric constant (e.g., d₃₁), a directionally dependent yield stress, and a directionally dependent ultimate tensile strength. Example high and ultra-high molecular weight polymer thin films may include polyethylene (PE) or polyvinylidene fluoride (PVDF), as well as combinations thereof, although additional polymer compositions are contemplated.

In some embodiments, an optical element may include a free-standing high or ultra-high molecular weight polymer thin film or a multilayer laminate including two or more of such polymer thin films. In further embodiments, an optical element may include a composite of a high or ultra-high molecular weight polymer thin film disposed over one or more major surfaces of a substrate. For instance, a high or ultra-high molecular weight polymer thin film may be laminated to one or both sides of a suitable substrate, such as a lens. A substrate, if provided, may include glass, ceramic, polymer, or other optically transparent material. An example polymer substrate may include polycarbonate. The high and ultra-high molecular weight polymer thin films disclosed herein may be light-weight, transparent, low haze, and birefringent.

A thickness of a high or ultra-high molecular weight polymer thin film may range from approximately 5 micrometers to approximately 100 micrometers or more, e.g., 5, 10, 20, 50, or 100 micrometers, including ranges between any of the foregoing values. A density of a high or ultra-high molecular weight polymer thin film may be less than approximately 1.5 g/cm³, e.g., 1 g/cm³ or 1.25 g/cm³.

In certain embodiments, an optical element may be located within the transparent aperture of an optical device such as a lens, although the present disclosure is not particularly limited and may be applied in a broader context. By way of example, an optical element may be incorporated into a tunable lens, thermally-conductive lens, impact resistant lens, accommodative optical element, adaptive optics, etc.

Example optical elements including an anisotropic polymer thin film may form a lens or a window in an artificial reality or virtual reality device. Further example optical elements may define a surface, e.g., of a watch, phone, tablet, TV, monitor, and the like, or form an interlayer, e.g., between a light source and a light receiver. An optical element may include a transparent substrate and a high or ultra-high molecular weight polymer thin film laminated to the substrate. An optical element may itself be optically transparent.

As used herein, a material or element that is “transparent” or “optically transparent” may, for a given thickness, have a transmissivity within the visible light spectrum of at least approximately 80%, e.g., approximately 80, 90, 95, 97, 98, 99, or 99.5%, including ranges between any of the foregoing values, and less than approximately 5% bulk haze, e.g., approximately 0.1, 0.2, 0.4, 1, 2, or 4% bulk haze, including ranges between any of the foregoing values. Transparent materials will typically exhibit very low optical absorption and minimal optical scattering.

As used herein, the term “approximately” in reference to a particular numeric value or range of values may, in certain embodiments, mean and include the stated value as well as all values within 10% of the stated value. Thus, by way of example, reference to the numeric value “50” as “approximately 50” may, in certain embodiments, include values equal to 50±5, i.e., values within the range 45 to 55.

As used herein, the terms “haze” and “clarity” may refer to an optical phenomenon associated with the transmission of light through a material, and may be attributed, for example, to the refraction of light within the material, e.g., due to secondary phases or porosity and/or the reflection of light from one or more surfaces of the material. As will be appreciated by those skilled in the art, haze may be associated with an amount of light that is subject to wide angle scattering (i.e., at an angle greater than 2.5° from normal) and a corresponding loss of transmissive contrast, whereas clarity may relate to an amount of light that is subject to narrow angle scattering (i.e., at an angle less than 2.5° from normal) and an attendant loss of optical sharpness or “see through quality.”

Features from any of the embodiments described herein may be used in combination with one another in accordance with the general principles described herein. These and other embodiments, features, and advantages will be more fully understood upon reading the following detailed description in conjunction with the accompanying drawings and claims.

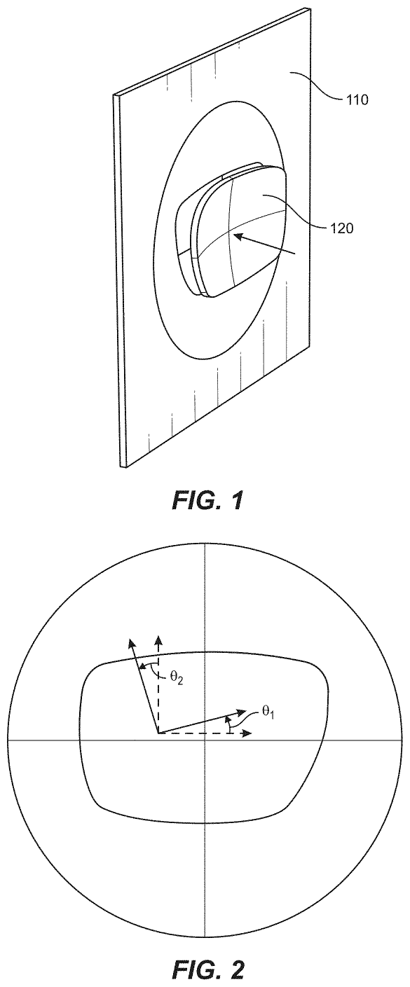

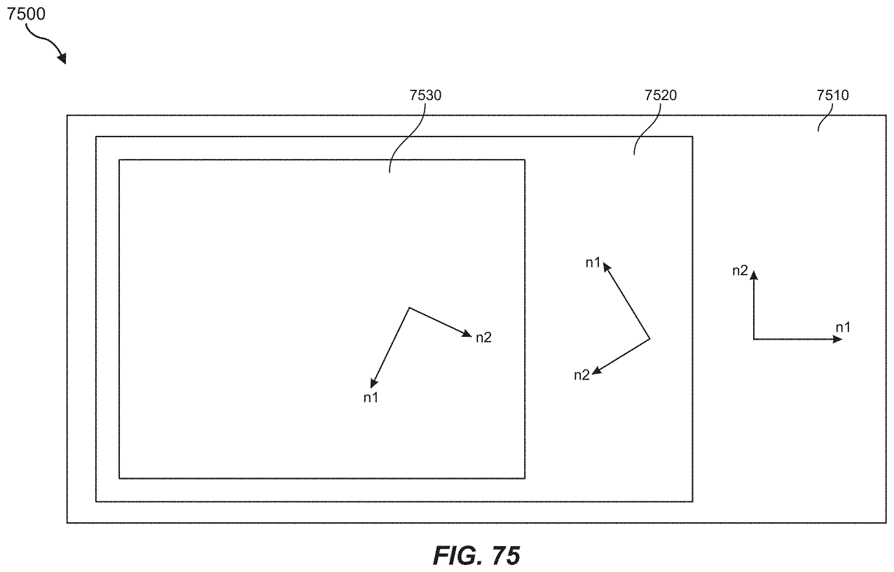

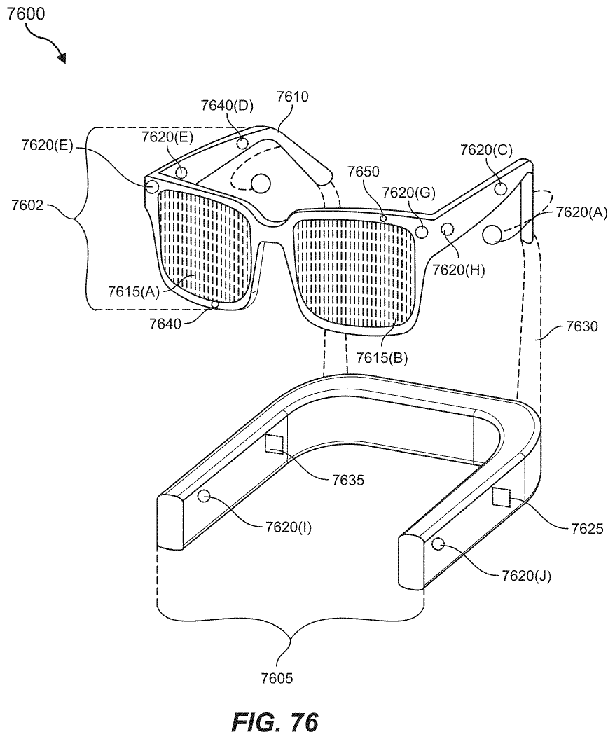

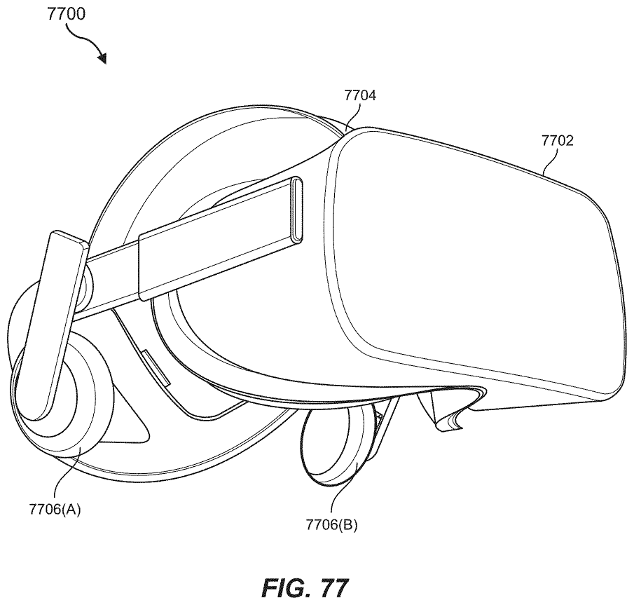

The following will provide, with reference to FIGS. 1-77, detailed descriptions of polymer thin films and thin film laminates, including their structures, properties, applications, and methods of manufacture. The discussion associated with FIGS. 1-75 includes a description of various processing schemes for forming components including optical elements having optical and/or mechanical anisotropy, as well as resulting architectures and associated properties. The discussion associated with FIGS. 76 and 77 relates to exemplary virtual reality and augmented reality devices that may include a thin film laminate as disclosed herein.

Depicted in FIG. 1 is an anisotropic polymer thin film 110 facing a backing layer (i.e., substrate) 120 having a compound curved shape. A frame (not shown) may be used to hold the backing layer 120. An adhesive may be applied to a facing surface of the polymer thin film, the backing layer, or both.

During an example process, the polymer thin film, the backing layer, or both may be heated to a temperature suitable to allow stretching of the thin film and bonding, if desired. The backing layer and the polymer thin film may be forced together as shown by the arrow. After bonding, the frame may be removed. By way of example, the polymer thin film 110 may be characterized by a thickness of approximately 200 micrometers and a modulus of approximately 50 GPa in the y-direction. The backing layer 120 may be characterized by a thickness of approximately 200 micrometers, a modulus of approximately 6 GPa, and a spherical curvature of −1.0 D.

In accordance with various embodiments disclosed herein, the act of stretching/bonding may include (1) aligning the polymer thin film with the backing layer and an intervening layer of adhesive, (2) bonding the polymer thin film to the backing layer and trimming the polymer thin film to the shape of the backing layer, and (2) freeing the backing layer to allow the composite lens to deform.

According to some embodiments, the anisotropic polymer thin film may have a normal stiffness of approximately 2 GPa in all directions, except the stretch (uniaxial) direction, where it may have a normal stiffness of approximately 50 GPa. In this example, the stretch direction is along the vertical direction (the shorter dimension of the lens). For ease of visualization, the thin film and the backing layer are both expanded by a factor of 10× in the thickness direction. This design may have relatively high and non-uniform stresses and strains that may be decreased by changes in the substrate geometry and the initial curvature of the composite.

In various embodiments, the anisotropic polymer thin film may include optical and/or mechanical anisotropic properties, including modulus of elasticity, yield strength, refractive index, selective absorption or reflection of polarized light, as well as combinations thereof.

Example polymer materials may include uniaxially oriented polyethylene, polyvinylidene fluoride, and its copolymers, polyethylene naphthalate, including 2,6-polyethylene naphthalate, polyethylene terephthalate, and polyvinyl alcohol. Example thin film geometries may include multilayer polymer architectures, such as multilayer reflective polarizers.

In various embodiments, the backing layer (lens) may include an optically clear material such as polycarbonate, cyclic polyolefin, CR39, high refractive index polymers, glasses, ceramics, and the like, as well as combinations thereof.

An adhesive, if used, may include a pressure sensitive adhesive such as an optically clear adhesive, a curable system such as a liquid optically clear adhesive, acrylics (for example, methacrylic acid and iso-butyl methacrylate), epoxies, urethanes, styrenes, cyanoacrylates, bismaleimides, phenolics, polyesters, and the like, as well as combinations thereof. Initiated resins may use radiation or thermally initiated materials, or combinations thereof. An adhesive may include a combination of a UV curable acrylate and a thermally cured epoxy.

A heating temperature may include temperatures greater than the glass transition temperature of the polymer thin film composition or, fora multilayer thin film, greater than the glass transition temperature of at least one component therein. Suitable temperatures may include those below, at, or about a melting temperature of the polymer thin film composition (or below, at, or about a melting temperature of at least one component in a multilayer film.

Referring to FIG. 2, shown schematically for an example lens architecture are material axes that are desirably kept undistorted while attaching a polymer thin film to the lens. A non-zero angle θ₁ indicates the extent of rotation for material that was originally horizontal before attaching the film to the lens. A non-zero angle θ₂ indicates the extent of rotation during forming for material that was originally vertical. In example methods, θ₁<0.4° and θ₂<0.4°.

According to some embodiments, a maximum variation of an angle of orientation of an extraordinary axis of the polymer thin film is at most 2% greater than an orientation variation associated with an initially planar polymer thin film formed to the compound curvature.

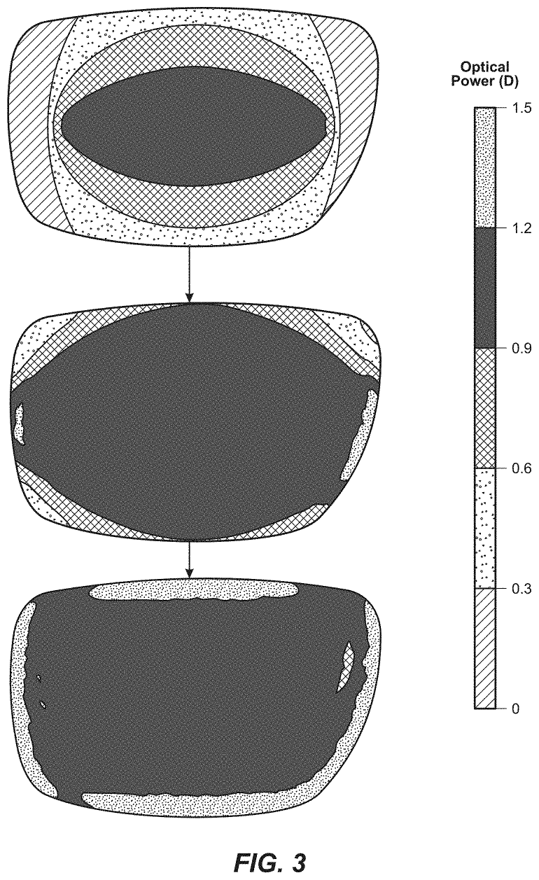

For the configuration of FIG. 1, FIGS. 3-9 show different results for stresses, strains, and optical uniformity during the forming step and after removal of the frame. FIG. 3 shows the change in spherical radius for the polymer thin film as the film is pressed against the substrate. In this example, 1 diopter of sphere is equivalent to a 670 mm spherical radius. FIG. 3 shows that the spherical shape is distorted near the horizontal and vertical edges of the lens. These edge regions have a higher diopter indicating a smaller radius of curvature.

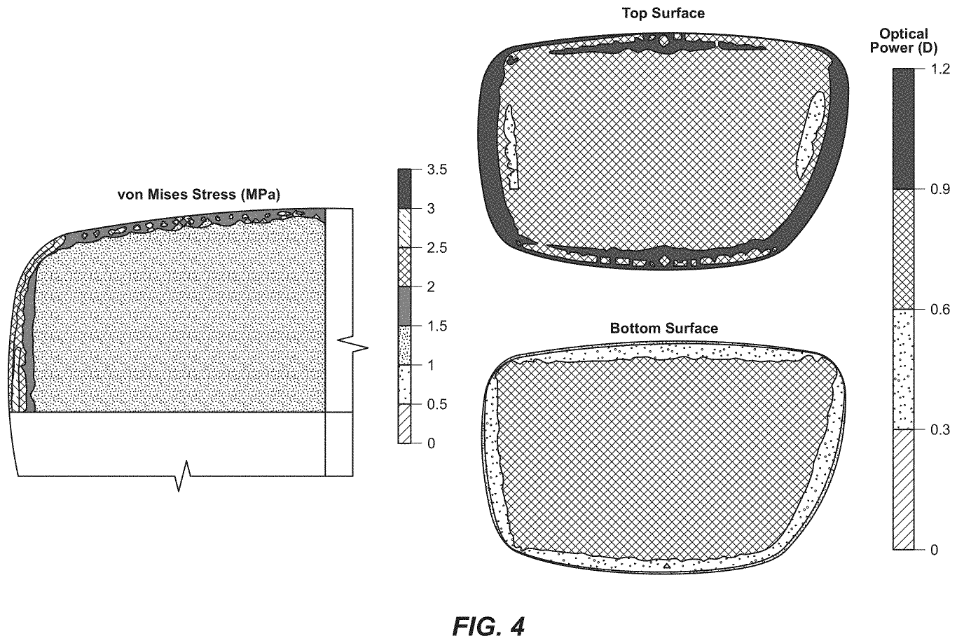

FIG. 4 shows the von Mises stresses in the polymer thin film after being formed to the shape of the substrate and released from a forming die/press. FIG. 4 also shows the optical power at the top and bottom surfaces of the lens. The results indicate that there is substantial local stress in the thin film near the edges that may cause distortion of the curvature.

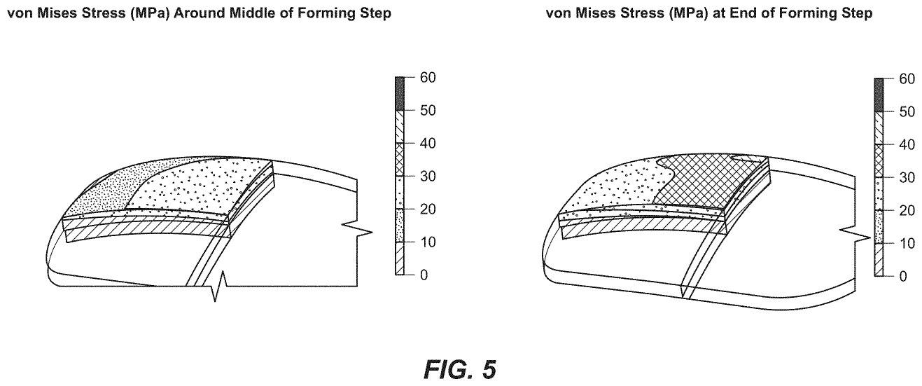

FIG. 5 shows the von Mises stresses in the polymer thin film and the substrate at the middle and the end of the forming step. The stresses are relatively uniform at the middle of the forming step, but close to the end of the forming step, stresses increase disproportionately at the top edge of the lens.

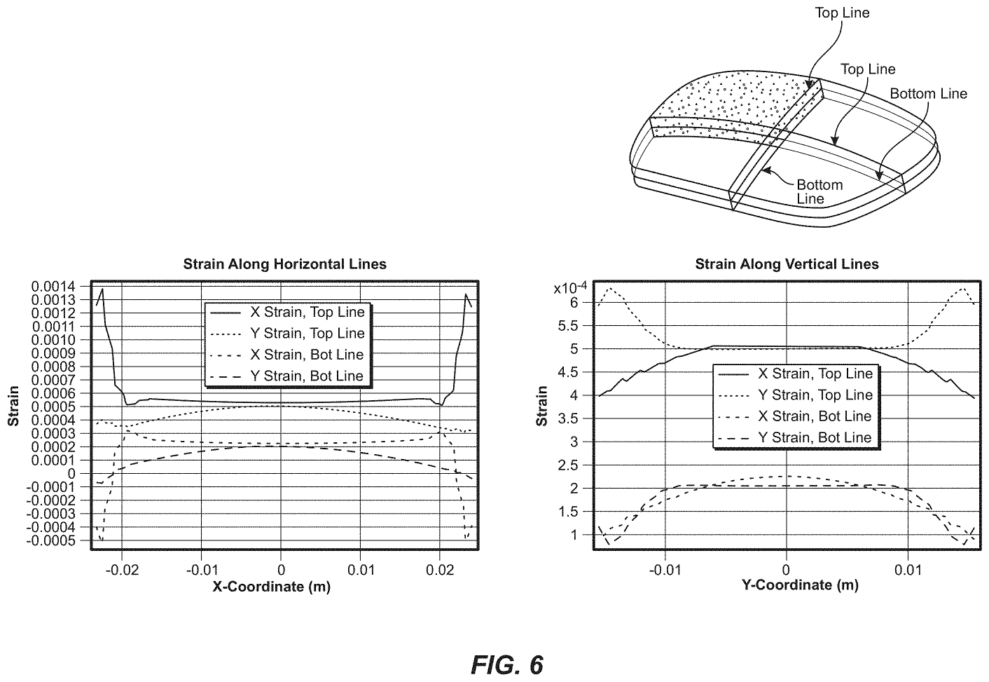

FIG. 6 shows the strain along horizontal lines (long axis) and vertical lines (short axis) at the end of the forming step. The strains are shown along two horizontal and two vertical lines. The “Top lines” are along the top surface of the lens, and the “Bottom lines” are at the bottom surface, where the bottom location corresponds to the top of the backing layer.

The strains are relatively uniform, except at the horizontal edges of the anisotropic polymer thin film where they sharply increase. The strains at the end of the forming step are “temporary” and will likely change when the frame is removed. Excessive strains may cause permanent deterioration in one or more characteristics including optical, electrical, and mechanical performance specifications.

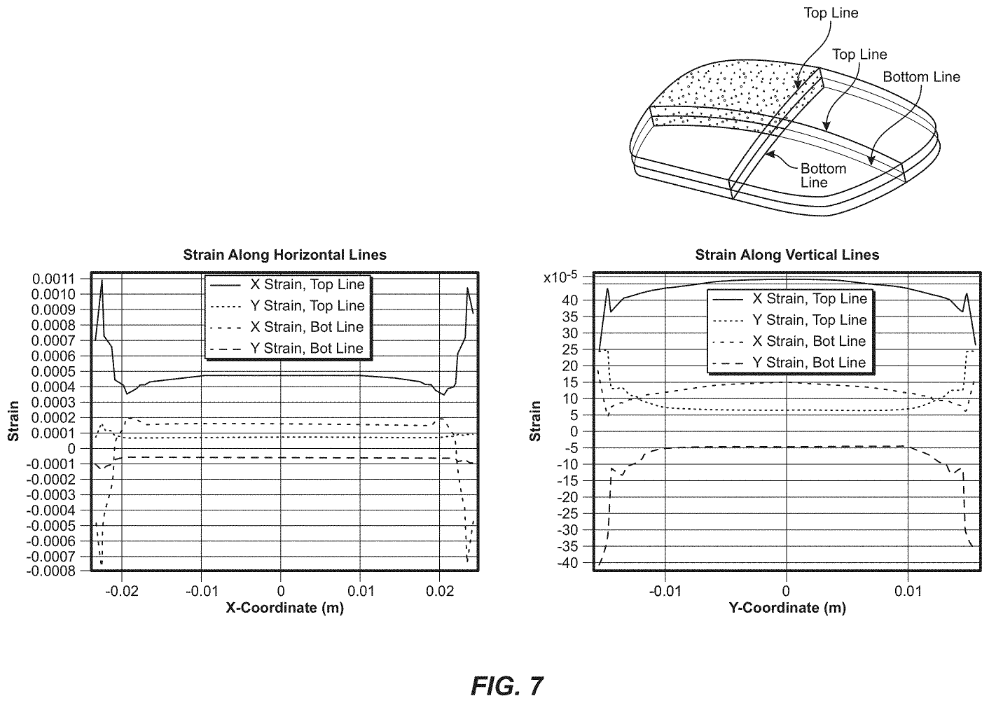

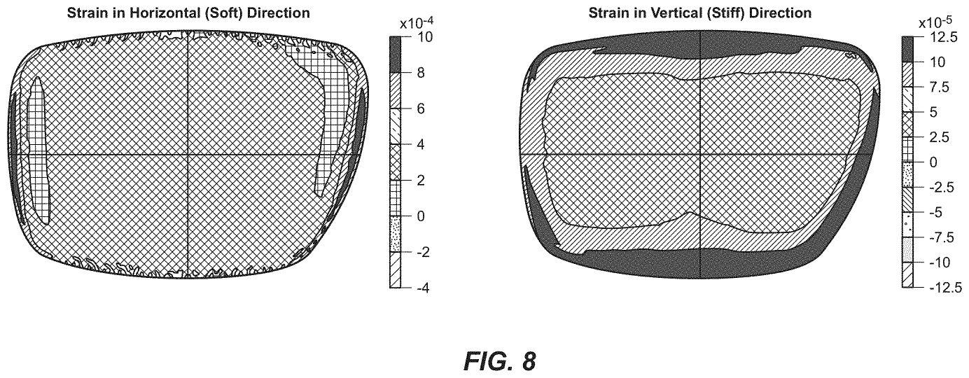

FIG. 7 shows the strains along the horizontal lines (long axis) and the vertical lines (short axis) at the end of the process when the frame. The strains are relatively uniform, except at the horizontal and top/bottom edges of the lens.

Shown in FIG. 8 are contour plots of the strains in the lens of FIG. 7 following lamination of the polymer thin film and following removal of the frame. The results highlight the locally high strains along the perimeter of the lens.

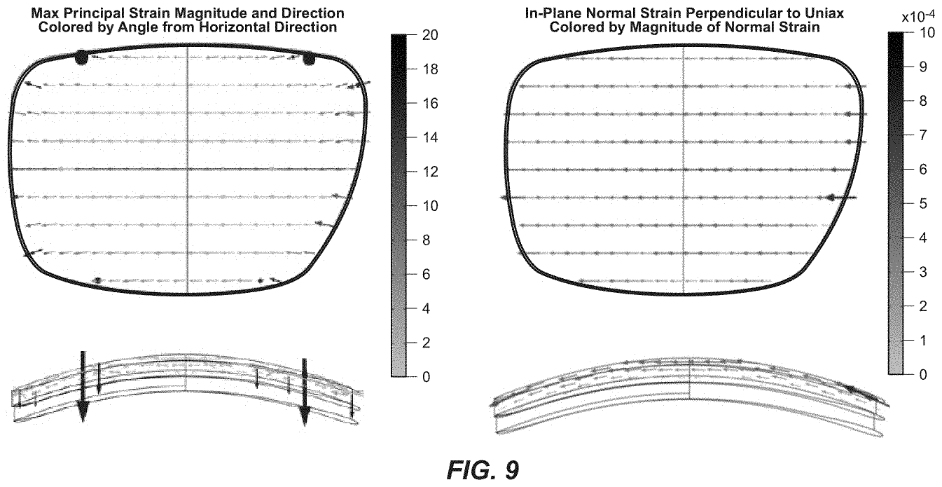

FIG. 9 shows the maximum principal strain vectors in the polymer thin film after the forming process (left view) where the direction of the maximum principal strain varies over the surface of the substrate. The magnitude and direction of the in-plane normal strain perpendicular to the uniaxial direction is shown in the view on the right. Changes in the direction of the principal stress or the magnitude of the strain normal to the uniaxial direction are indicators of nano or micro cracking within the polymer thin film.

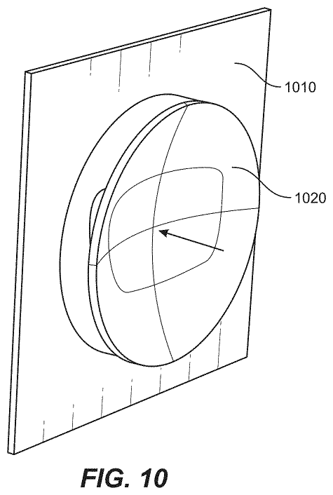

FIGS. 10-18 depict an example method and apparatus for improving the stress and strain uniformity over the relevant lens-shaped area of a substrate 1020 by extending the substrate shape with a circular surrounding area. The extended shape substantially improves the uniformity of the spherical radius over the relevant (e.g., viewing) area of the substrate. The forming process involves a frame that presses the backing layer as in the original design of FIG. 1, and further includes cutting out the lens shape from the extended geometry and removing the frame that is pushing the backing layer. The geometry and material properties of the anisotropic film 1010 and the backing layer 1020, in this example, are otherwise identical to those used in the example of FIG. 1.

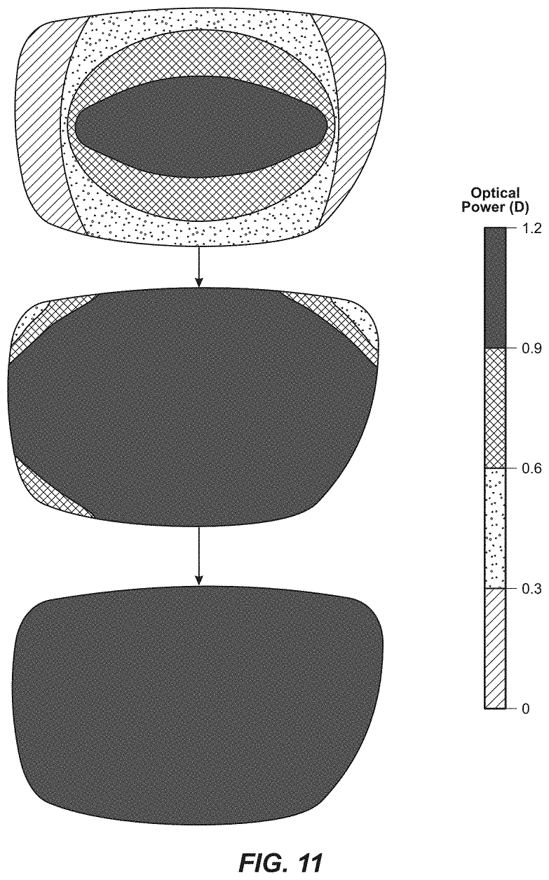

FIG. 11 shows the change in spherical radius for the polymer thin film of FIG. 10 as the thin film is pressed against the substrate. In the current example, 1 diopter of sphere is equivalent to a 670 mm spherical radius. FIG. 11 shows that the spherical shape at the end of the forming process is uniform, in contrast to FIG. 3.

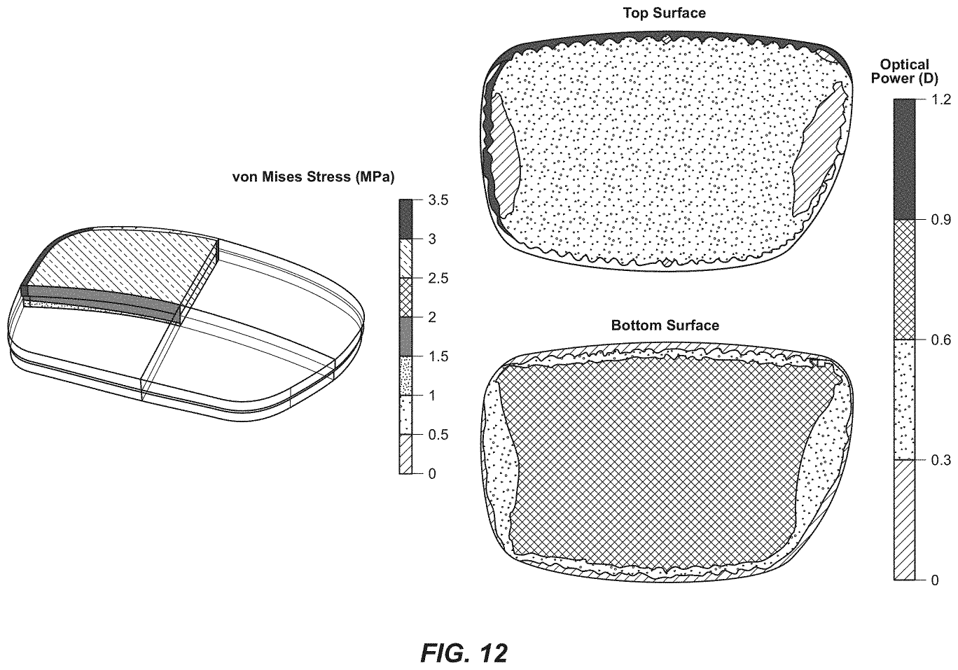

FIG. 12 shows the von Mises stress in the polymer thin film after removing the frame holding the backing layer, and also shows the optical power at the top and bottom surfaces of the lens. The average optical power in the lens is approximately 0.66 D. The results show that there is less stress localization and less optical distortion at the edges, compared to the initial design of FIG. 1.

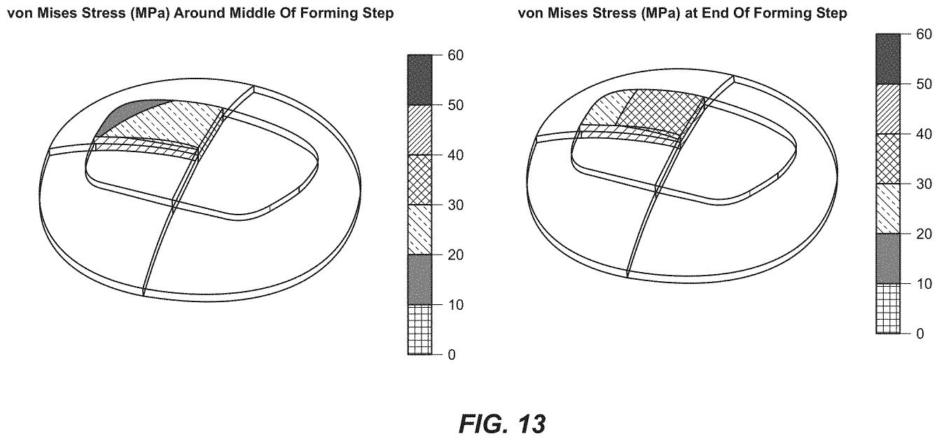

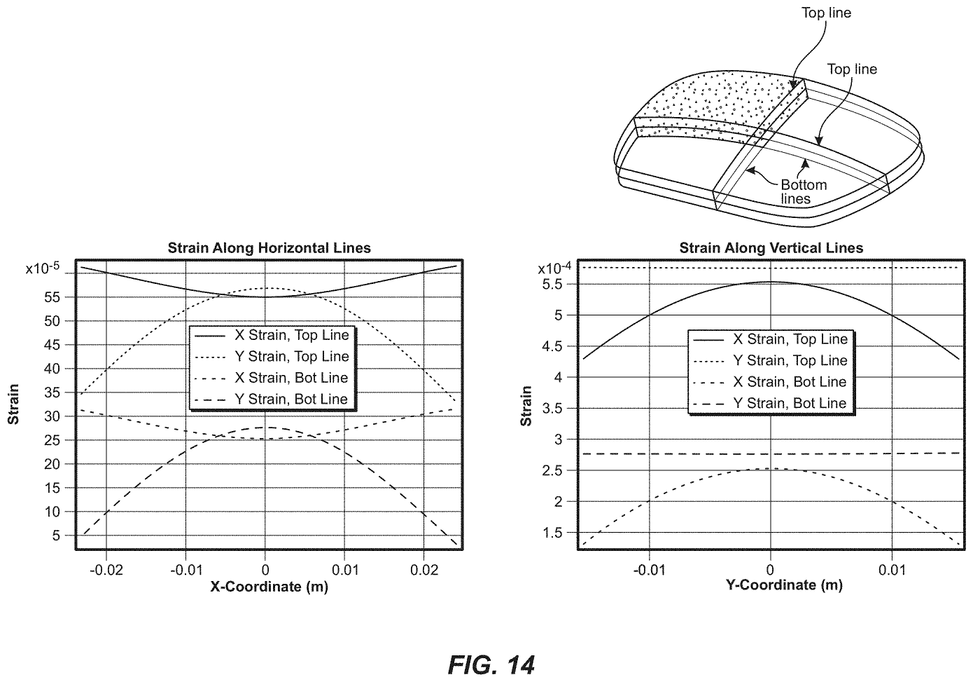

FIG. 13 shows the von Mises stresses in the polymer thin film and in the substrate at the middle and at the end of the forming step. Compared to the design of FIG. 1, the stresses are relatively uniform at the middle and at the end of the forming step. FIG. 14 shows the strains along the horizontal lines (long axis) and vertical lines (short axis) at the end of the forming step. The strains are relatively uniform, in contrast to the design of FIG. 1 where the backing layer is not extended, and less than approximately 0.06% in both directions.

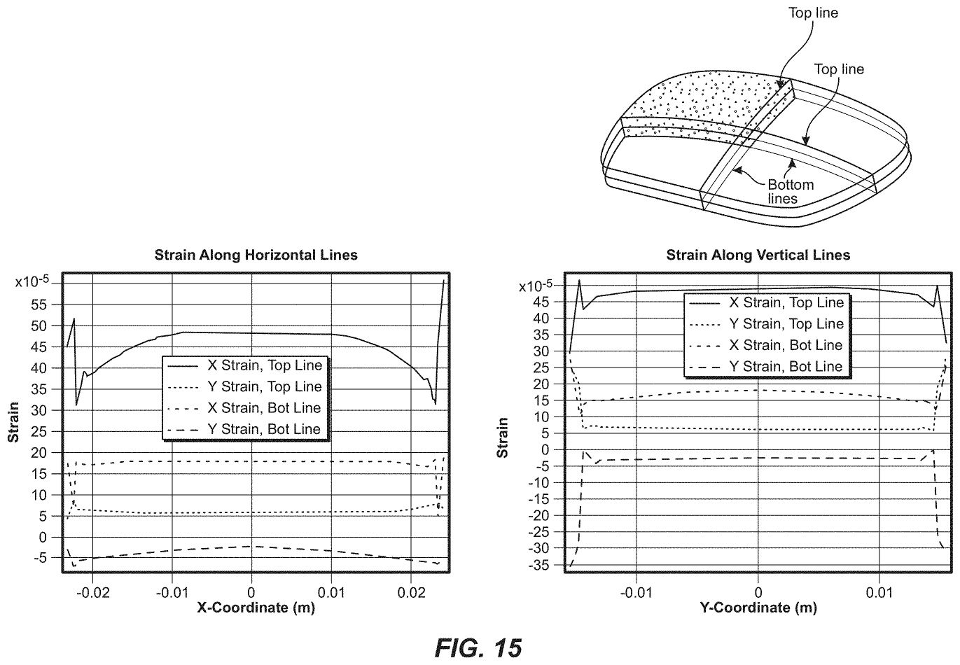

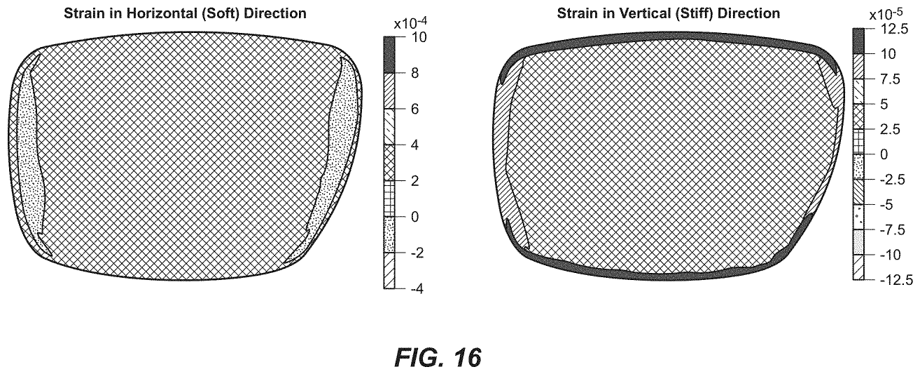

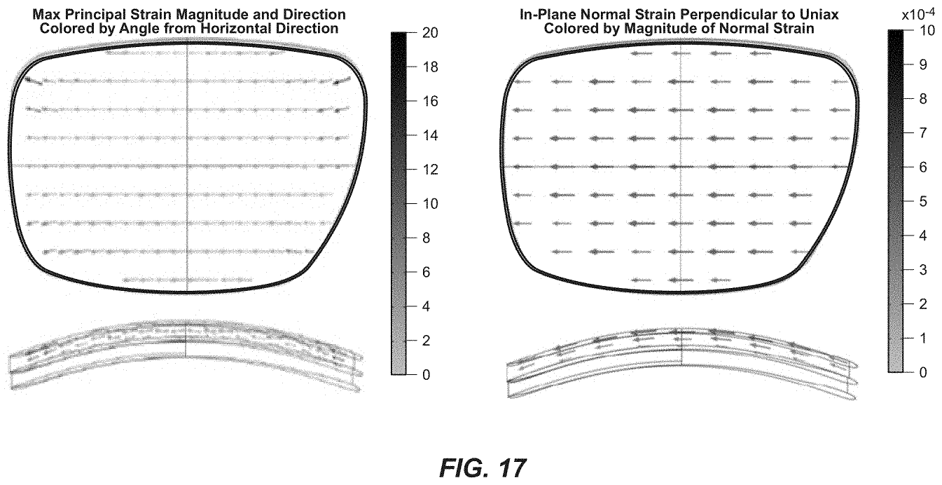

FIG. 15 shows the strains along the horizontal lines (long axis) and vertical lines (short axis) as in FIG. 14, but after removing the frame holding the backing layer. The strains are relatively uniform, unlike the design of FIG. 1, where the backing layer is not extended. FIG. 16 shows the strains following removal of the frame holding the backing layer, as in FIG. 15, but as a contour plot. In the illustrated example, the strains are less than approximately 0.06% along the x-direction and less than 7×10⁻⁵ along the y-direction. The results highlight the decrease in strain at the perimeter relative to an un-extended backing layer. FIG. 17 shows the maximum principal strain vectors in the polymer thin film after the forming process (left view). The direction of the maximum principal strain varies slightly over the surface of the substrate, especially close to the edges. The magnitude and direction of the in-plane normal strain perpendicular to the uniaxial direction is shown in the view on the right. The in-plane normal strain is uniform in direction, but its magnitude changes along the horizontal direction.

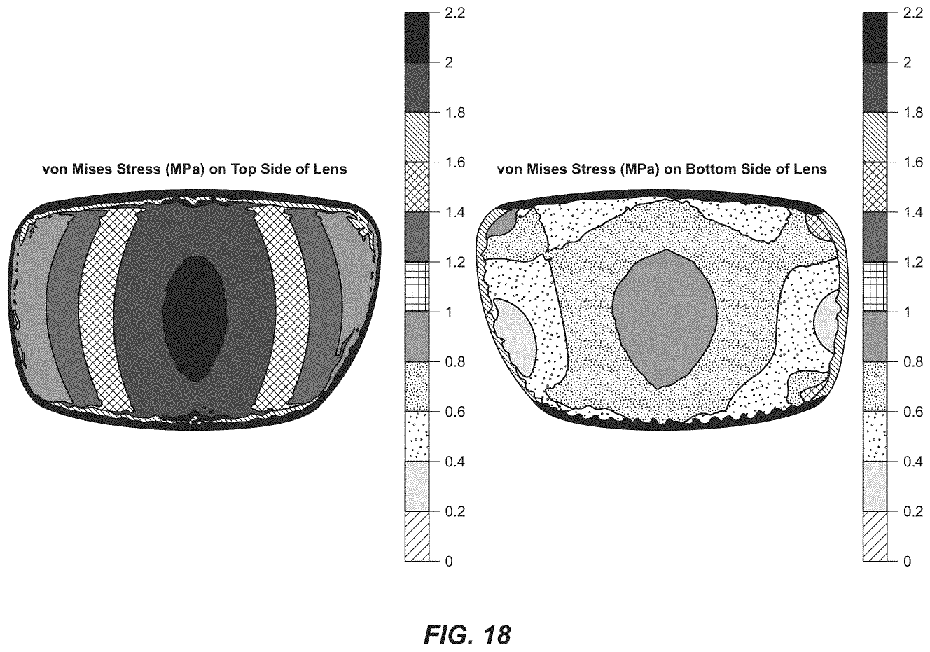

FIG. 18 shows the von Mises stresses on the top and bottom surfaces of the lens (not the film). The stresses do not exceed 1.9 MPa, which is not excessive for this lens material having a modulus of 6 GPa. Note that the high stresses along the edges are a numerical modeling artifact. The stresses vary through the thickness indicating that the lens is in a bending stress state. The stresses can be lowered by using the methods described earlier, i.e., softer films, thinner films, heat treatment before releasing from the tool, a double-sided film to balance the initial stresses, and/or by relocating the clamped film boundaries inward during forming to decrease the initial stresses.

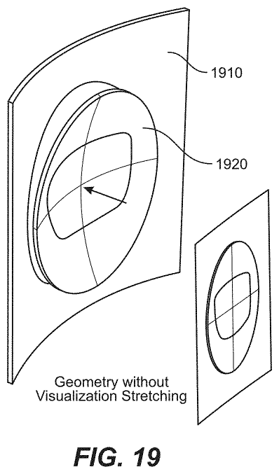

Referring to FIGS. 19-26, shown is a further approach to managing strain and stress-vector direction, where the polymer thin film 1910 has an initial cylindrical curvature about the vertical axis, with a radius of 1.0 meters (larger than the 0.67 m spherical radius of the substrate 1920). The figures present data analogous to the previous two examples.

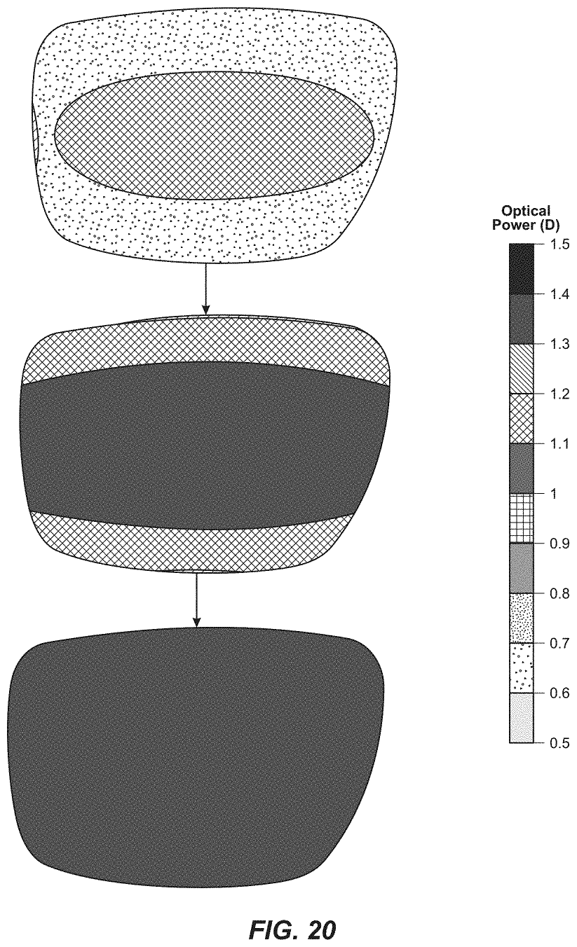

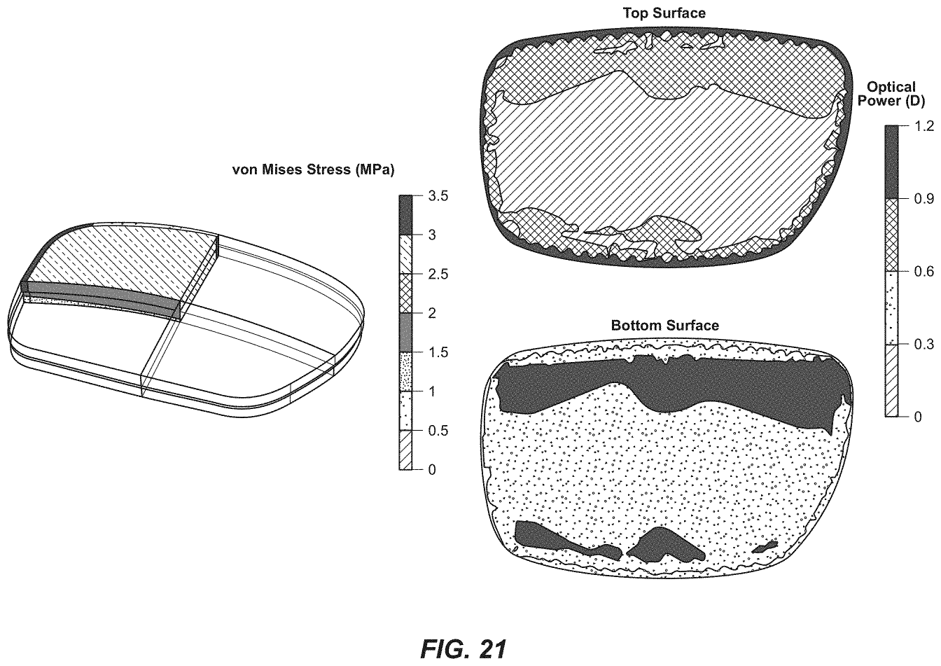

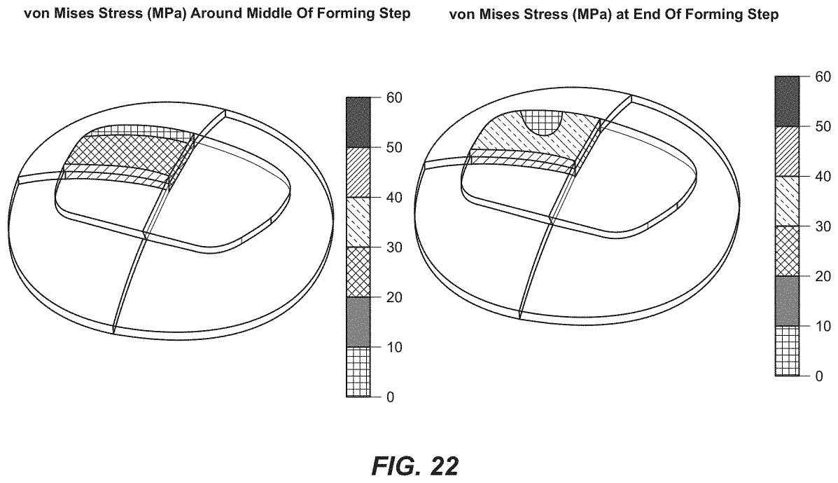

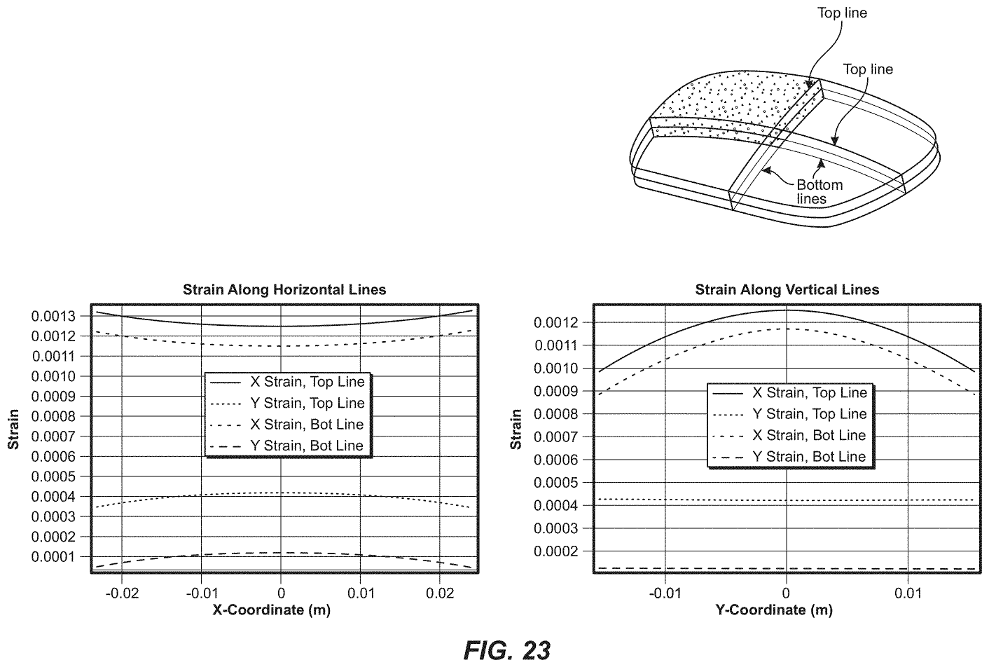

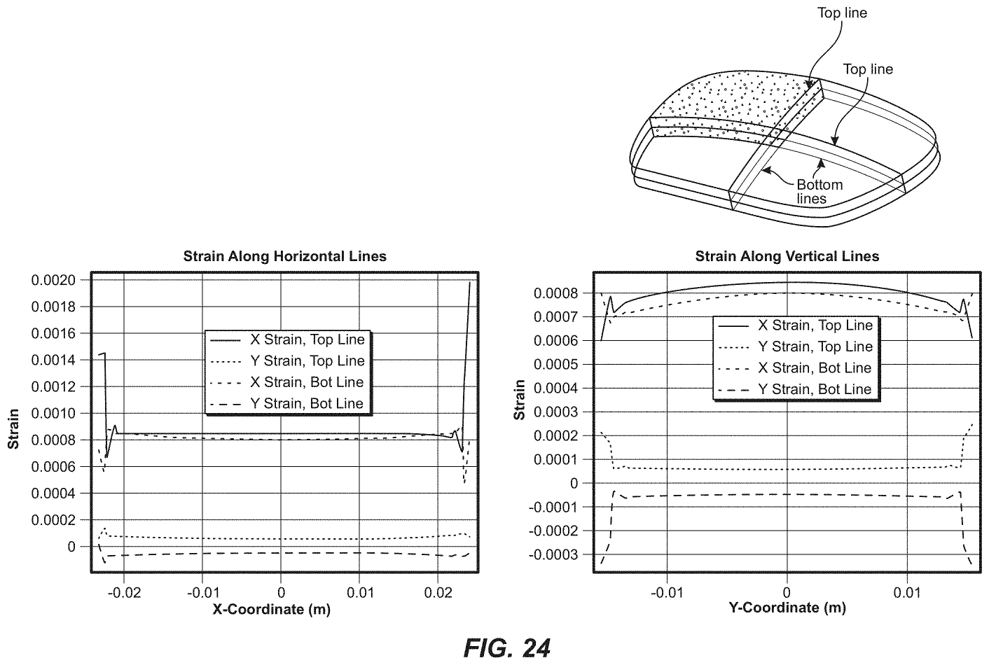

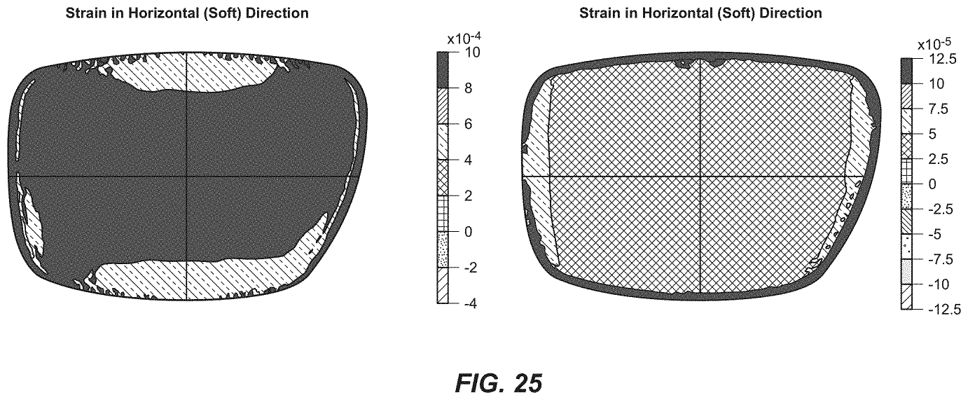

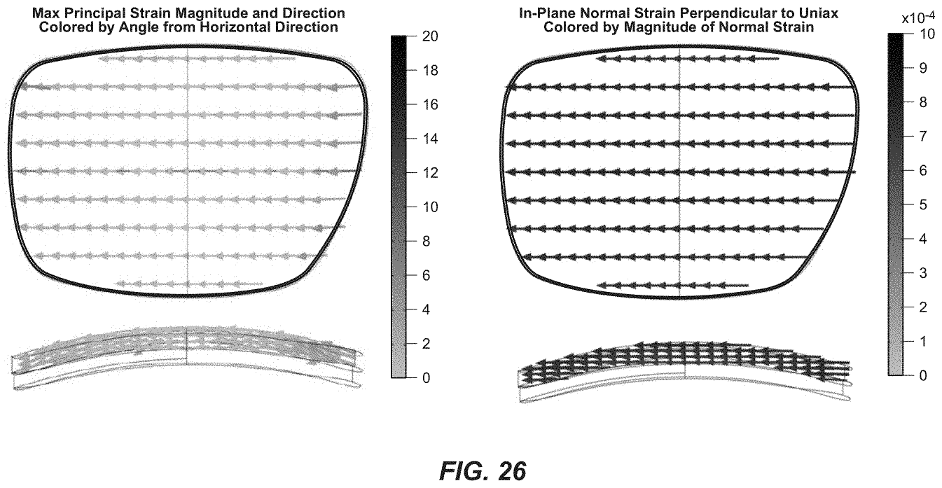

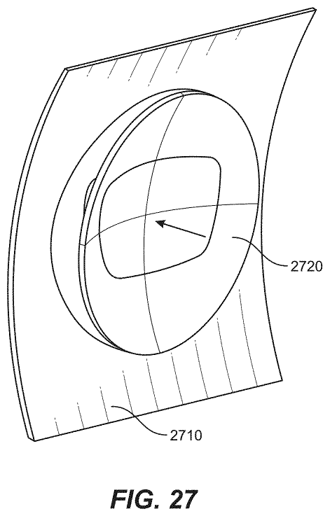

FIG. 20 shows that the optical power variation during forming is different than that shown in FIG. 11. However, it is still uniform at the end of the process. FIG. 21 and FIG. 22 show that the von Mises stresses after forming are slightly lower than the flat case. FIG. 23 and FIG. 24 show that the strains are relatively higher than the flat film case, but more spatially uniform. FIG. 25 showing the strain contours reveals the same trend as displayed in FIGS. 23 and 24. FIG. 26 shows the uniformity of the maximum principal strain vectors in the polymer thin film after the forming process (left view) and the uniformity of the in-plane normal strain perpendicular to the uniaxial direction (right view).

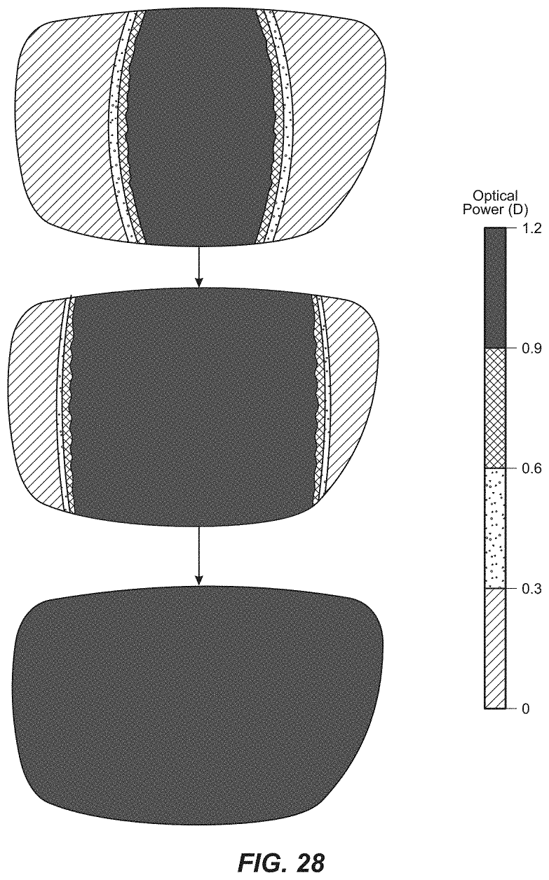

FIGS. 27-34 show a third approach to managing strain and stress-vector directions, where the polymer thin film 2710 has an initial cylindrical curvature about the horizontal axis and a radius of 1.0 meters (larger than the 0.67 m spherical radius of the substrate 2720). This is identical to the second approach (FIG. 19) except for the horizontal instead of vertical direction of the axis of the cylinder. The figures reveal data analogous to those shown in the previous two examples.

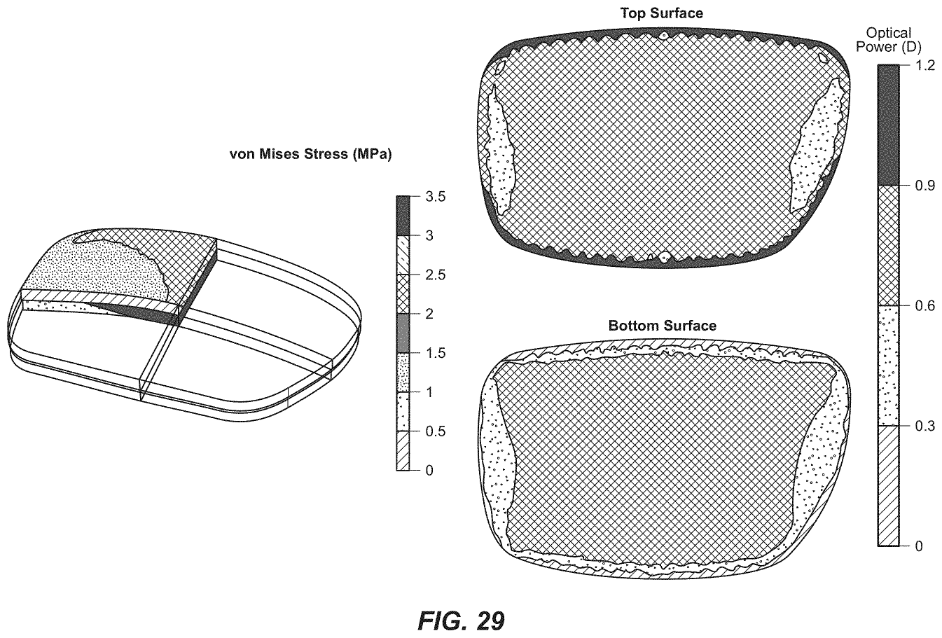

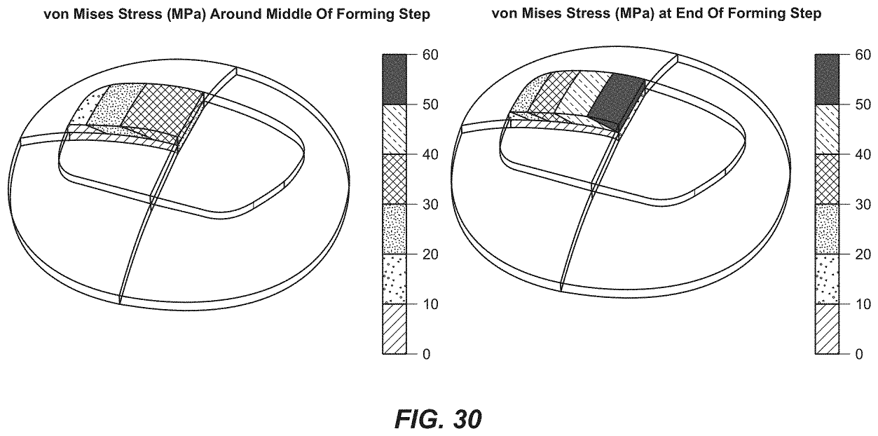

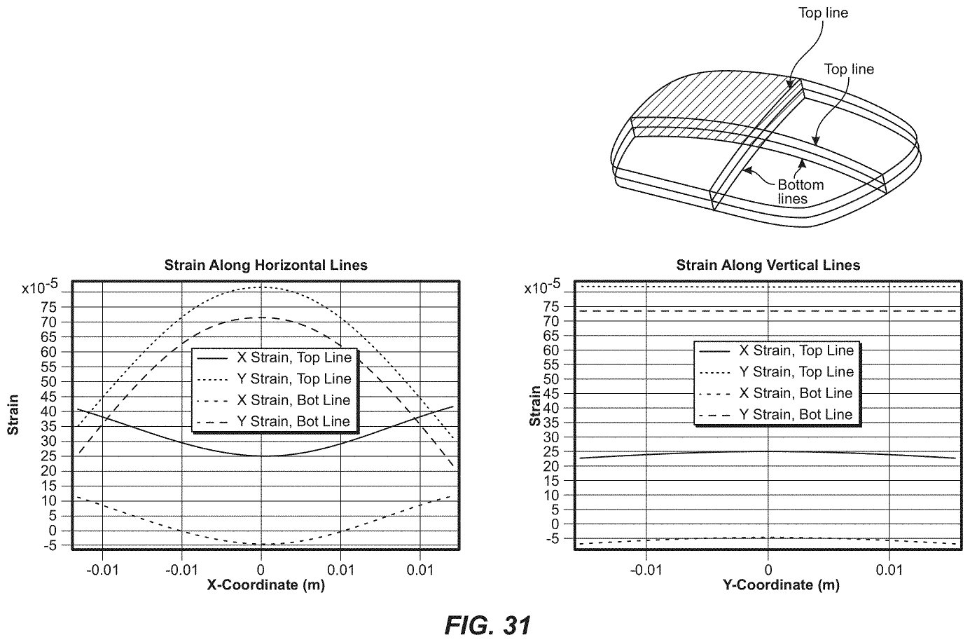

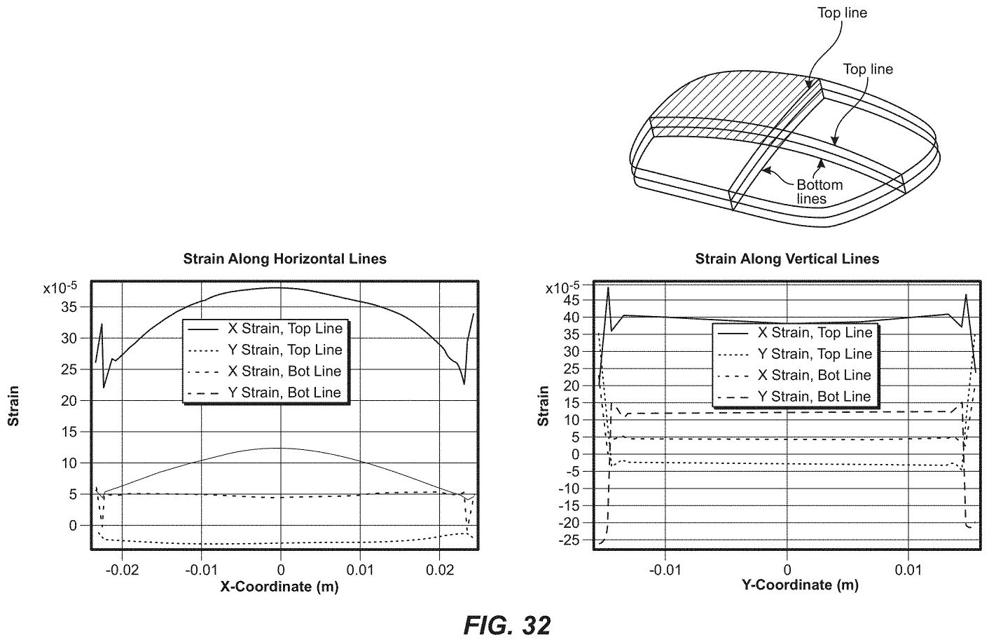

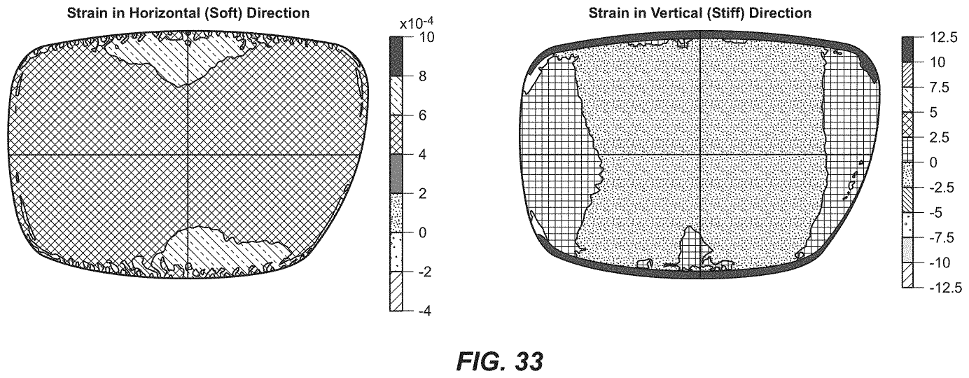

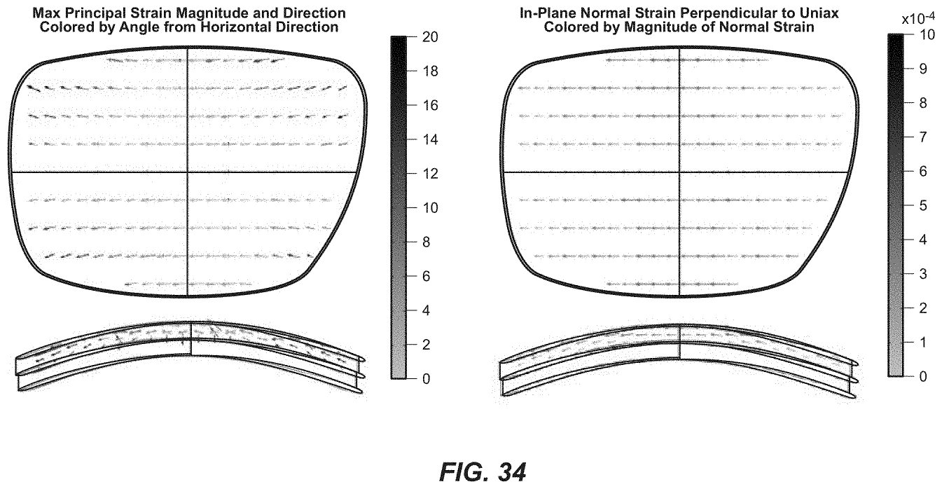

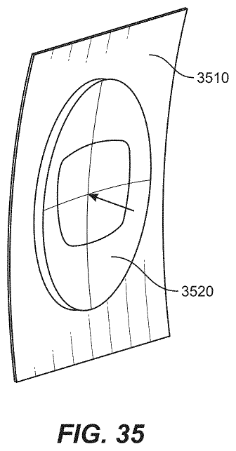

FIG. 28 shows that the optical power variation during forming is different than in the previous cases. However, it is still uniform after forming. FIG. 29 shows that the von Mises stresses during the forming step are less than the flat case, whereas FIG. 30 shows that the von Mises stresses after forming are greater than the flat case. FIG. 31 and FIG. 32 show that the strains in the weaker x direction are less than for the flat case (0.04% compared to 0.06% following the forming step and 0.04% compared to 0.05% after releasing the backing layer) whereas the strains in the y direction are greater than for the flat case (0.08% compared to 0.06% following the forming step and 12×10⁻⁵ compared to 6×10⁻⁵ after releasing the backing layer). FIG. 33 showing the strain contours shows the same trend as in FIGS. 31 and 32. FIG. 34 shows slightly less uniformity in the maximum principal strain vector in the polymer thin film after the forming process (left view). This forming configuration may therefore be more suitable when the primary concern in the design are the strains in the weaker x direction. The design approach presented above also is helpful for cases where the compound radius of curvature is smaller. This forming method may also be suitable for cases where the lens has a higher compound curvature (lower radius of curvature).

In the next several examples, the polymer thin film has an initial radius of curvature of 200 mm (instead of 0.67 m). The higher curvature results in higher strains in the film than the 0.67 m curvature cases. However, the strains are still relatively uniform, and the strain directions are not significantly altered.

FIGS. 35-39 describe an embodiment where the stiffness of the polymer thin film is 20 MPa in the weak direction, roughly 100× softer than its room temperature stiffness, and 25× stiffer in the stretch direction (500 MPa). The polymer thin film 3510 in this example is initially flat, and the substrate 3520 is a stiff glass layer, but it can be a softer material as in the previous examples.

The forming method includes the same steps shown in the previous examples. The figures are to scale. They are not stretched in the z-direction for better visualization (unlike the previous examples). In this embodiment, a circular skirt is added around the lens shape. The figures shown here are a subset of what was shown in the previous examples.

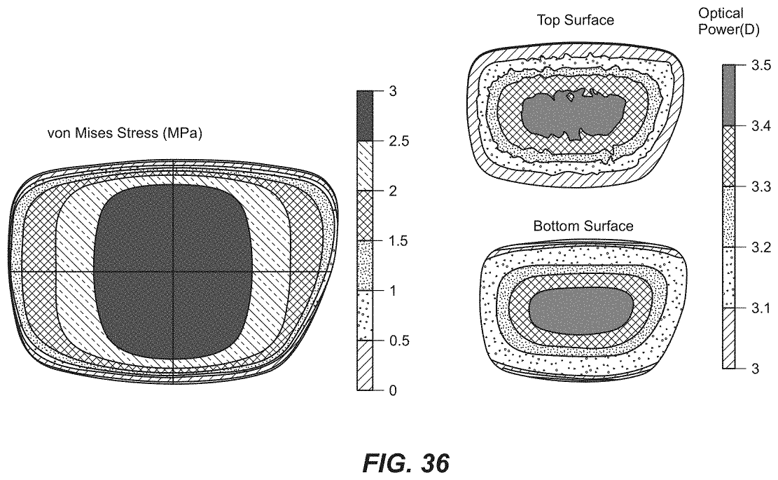

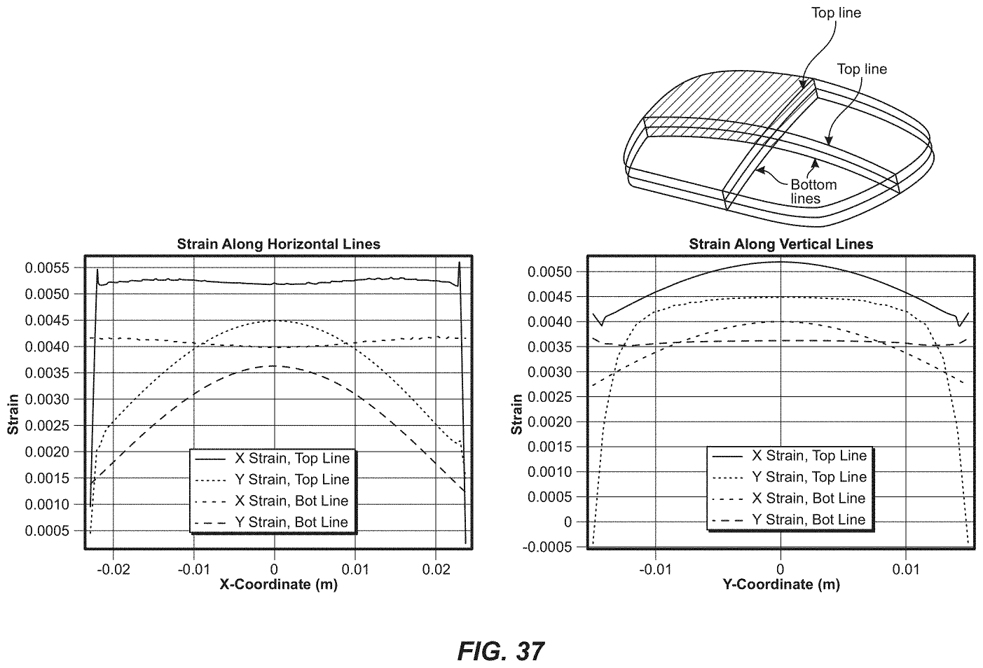

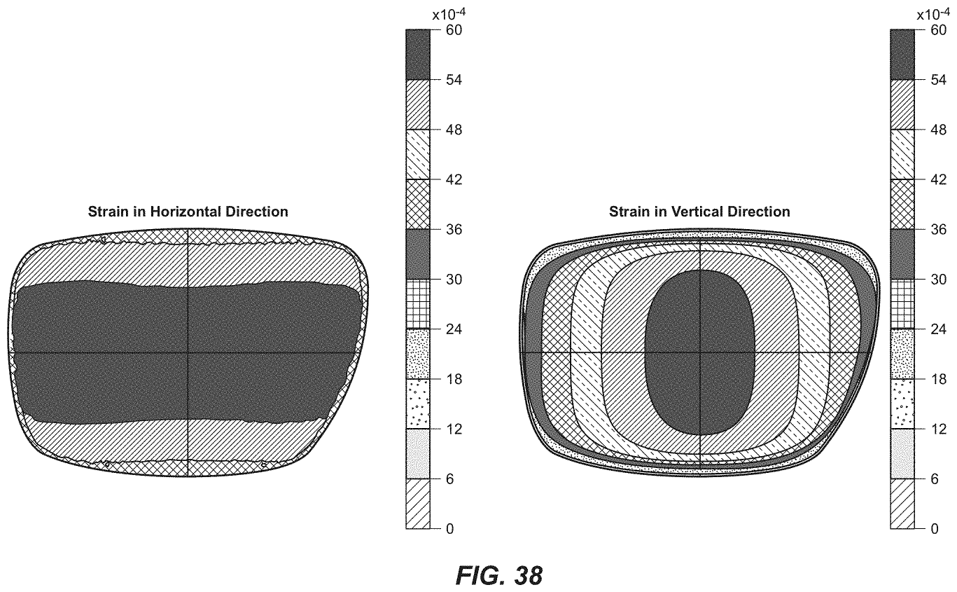

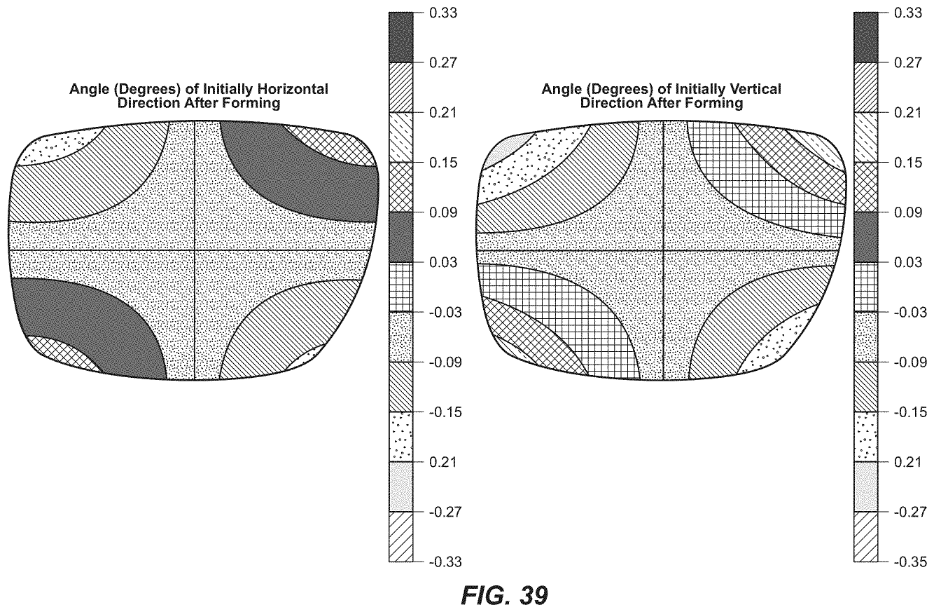

FIG. 36 shows that the stresses are not high in the polymer film, and the optical power varies between 3 and 3.5 diopters (based on a refractive index of 1.65). FIG. 37 shows the strains are generally low over the polymer thin film. However, the strains vary between the top and bottom surfaces of the film, and they vary as well in the hoop (circumferential) direction. FIG. 38 provides another perspective showing that the strains are overall low over the film, and also more uniform in the weaker x direction. FIG. 39 shows that the material directions that start out horizontal or vertical do not rotate or distort appreciably due to the forming process. The maximum change in the material directions is approximately 0.3 degrees.

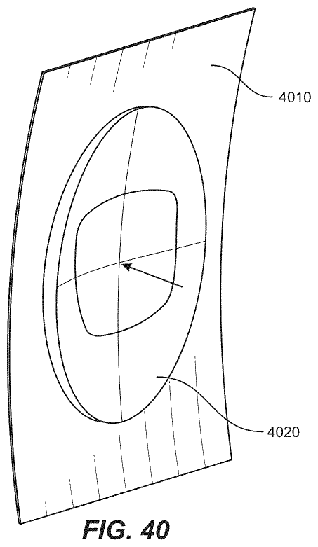

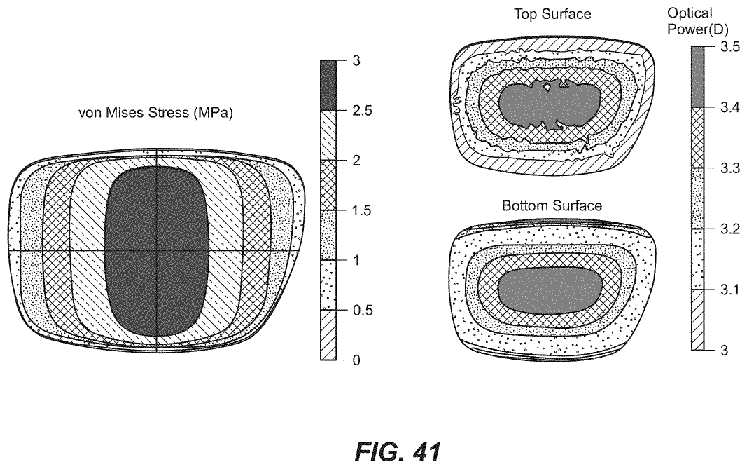

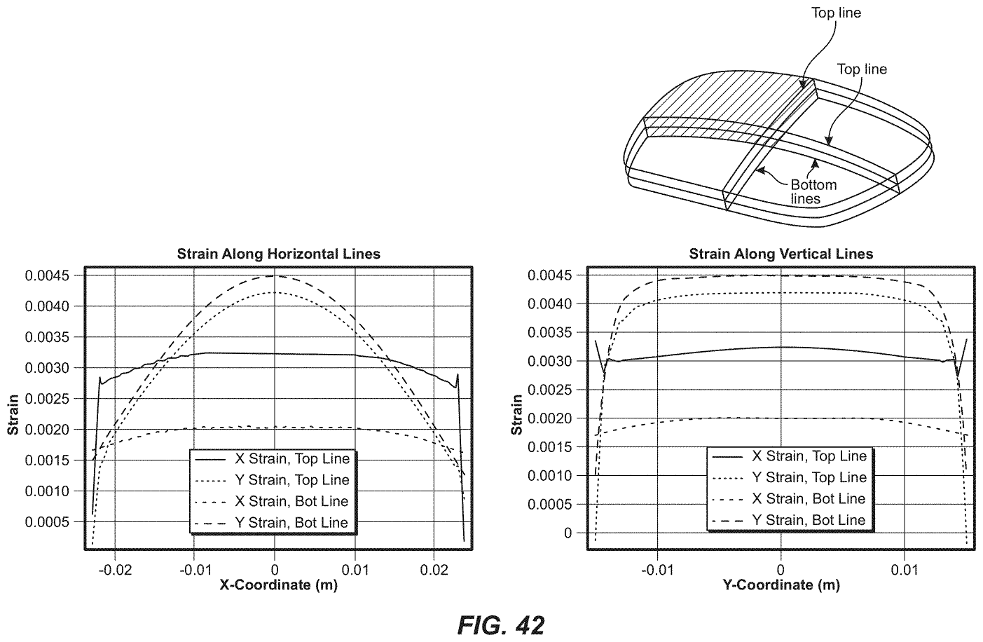

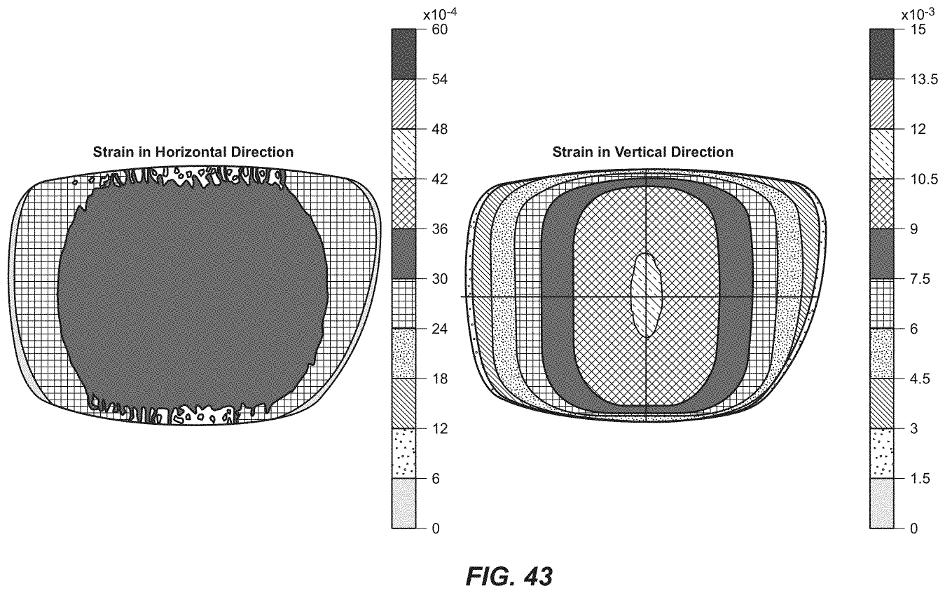

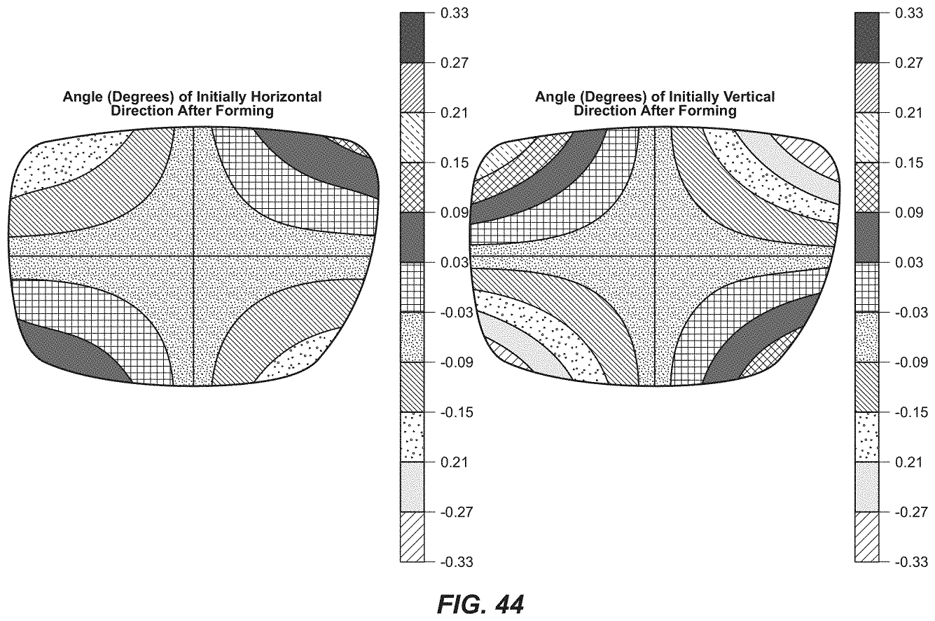

FIGS. 40-44 show an embodiment analogous to the previous embodiment, where the polymer thin film 4010 now is initially curved as a cylinder having a radius of 0.25 m in the vertical direction and the substrate 4020 is curved as a sphere with a radius of curvature of 250 mm. FIG. 41 shows that the stresses are relatively similar to the previous case. FIG. 42 shows that the strains are relatively lower in this case, and are less varying through the thickness of the polymer thin film, and less varying in the vertical (stiffer) direction. FIG. 43 shows another perspective on the strains showing that they are low and more uniform than the flat film case. FIG. 44 shows that the material directions that start out horizontal or vertical do not rotate or distort appreciably due to this forming process. This variant of the forming process may be more suitable when the maximum strains in the stiffer x direction are desirably small.

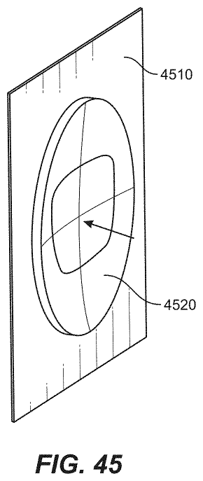

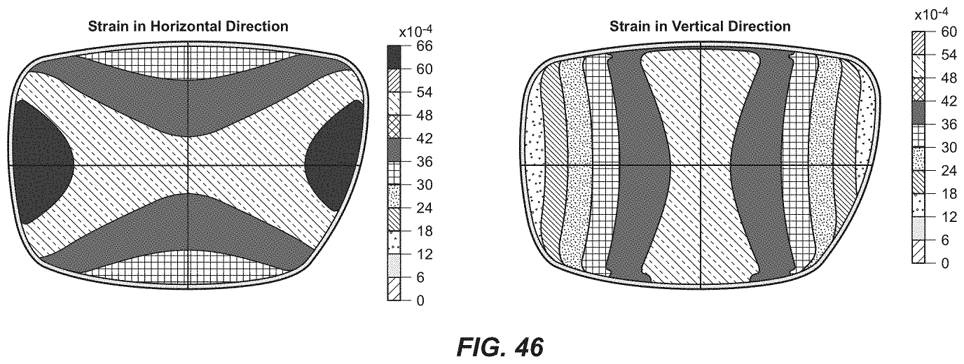

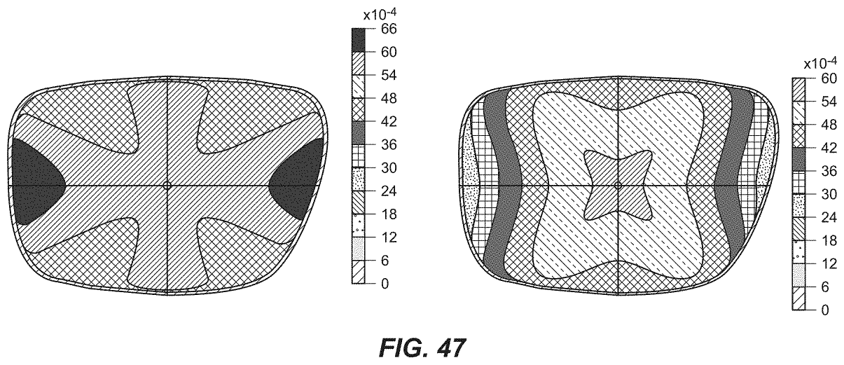

FIGS. 45-49 illustrate the effect of the initial cross-sectional shape of the polymer thin film 4510 for the case of a 20 MPa isotropic flat thin film formed over a spherical substrate 4520 having a radius of curvature of 200 mm. FIG. 45 describes the case of a rectangular film, as in the previous examples. FIG. 46 shows the horizontal and vertical strains as depicted earlier. FIG. 47 shows the same strains resolved in the radial and hoop directions, and illustrates that the radial strains and hoop strains vary over the lens surface.

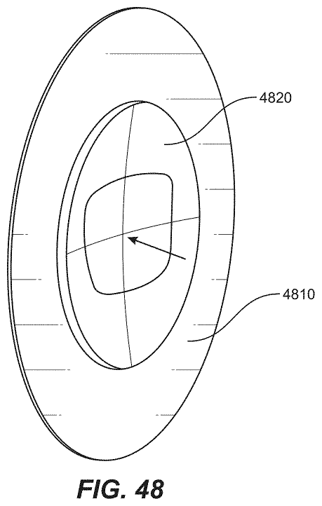

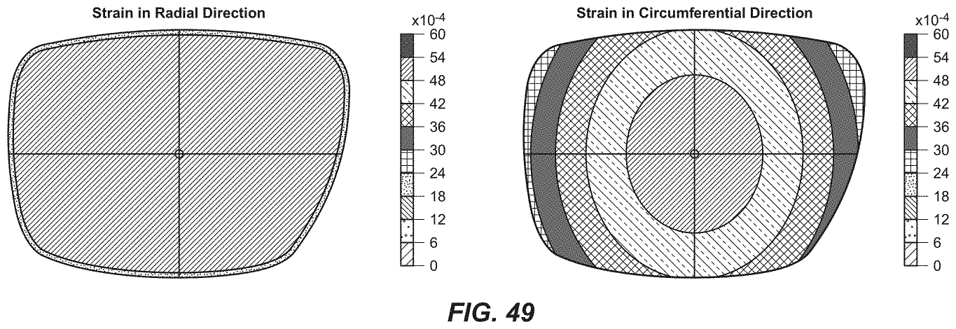

Referring to FIG. 48, when a circular polymer thin film 4810 is used in place of a thin film having a rectangular section, and the substrate 4820 is kept as a spherical shape with a 200 mm radius of curvature, the results are different. FIG. 49 shows that the radial strains are nearly uniform, while the hoop strains are quadratically varying. This variation is consistent with the theoretical deformation gradient that results from deforming a flat film to a compound curved surface.

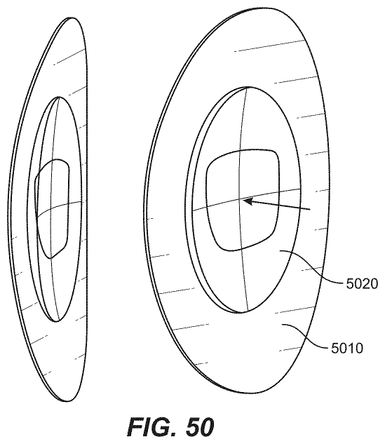

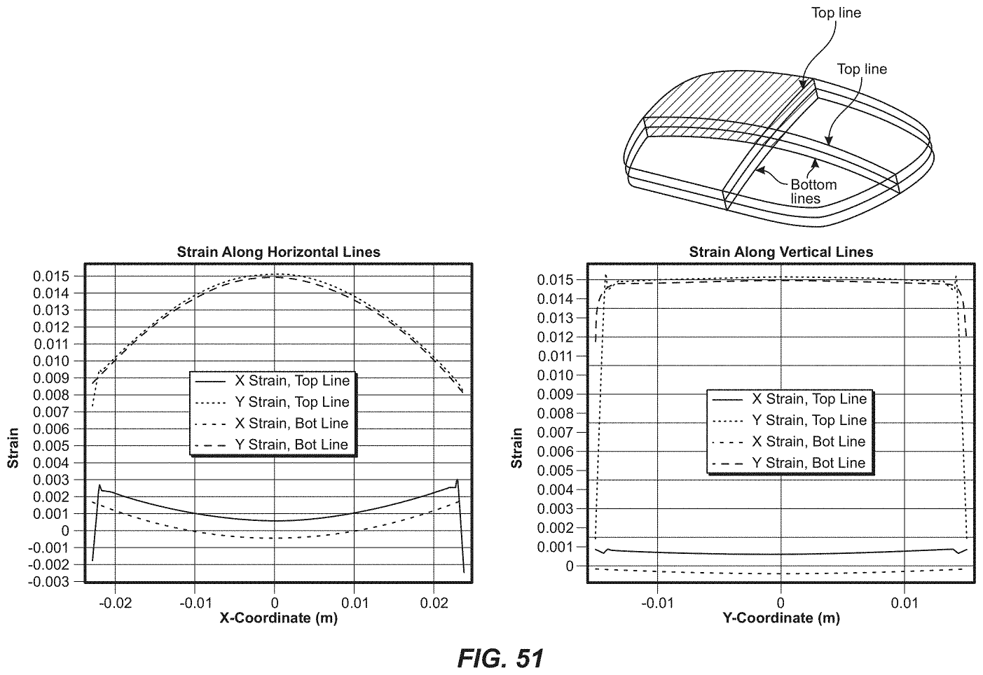

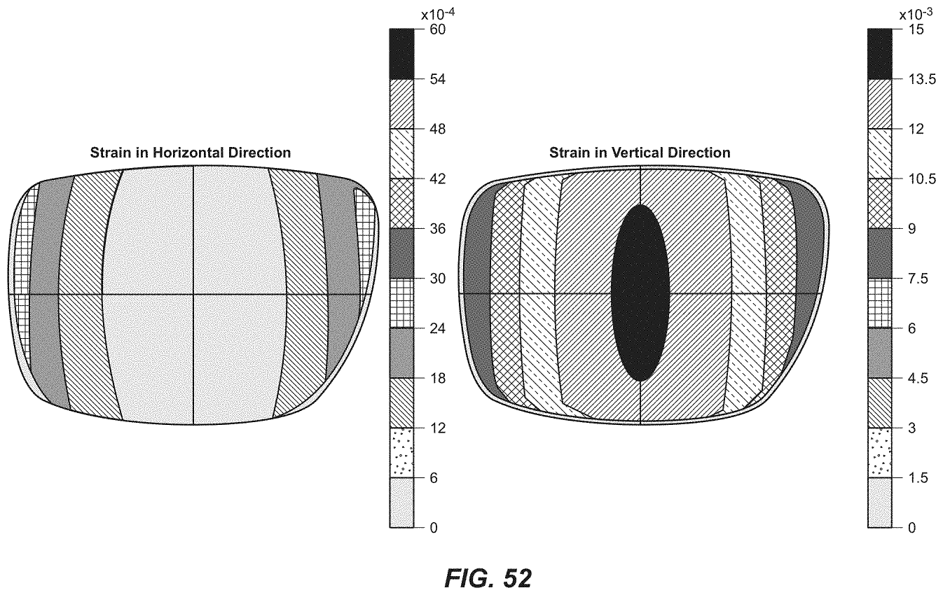

According to a further embodiment, FIGS. 50-55 illustrate another effect of the initial shape of the polymer thin film for the case of a 20 MPa isotropic film. In this case the polymer thin film 5010, as shown in FIG. 50, is part of a cylindrical surface having a radius of curvature of 250 mm, and has a circular cut-out. The substrate 5020 has a constant spherical shape with a 200 mm radius of curvature. FIG. 51 shows the strains in the horizontal and vertical directions along highlighted lines. Compared to an initially flat thin film, the cylindrical shaped film results in higher y direction strains and lower x direction strains. This is also shown as a contour plot in FIG. 52.

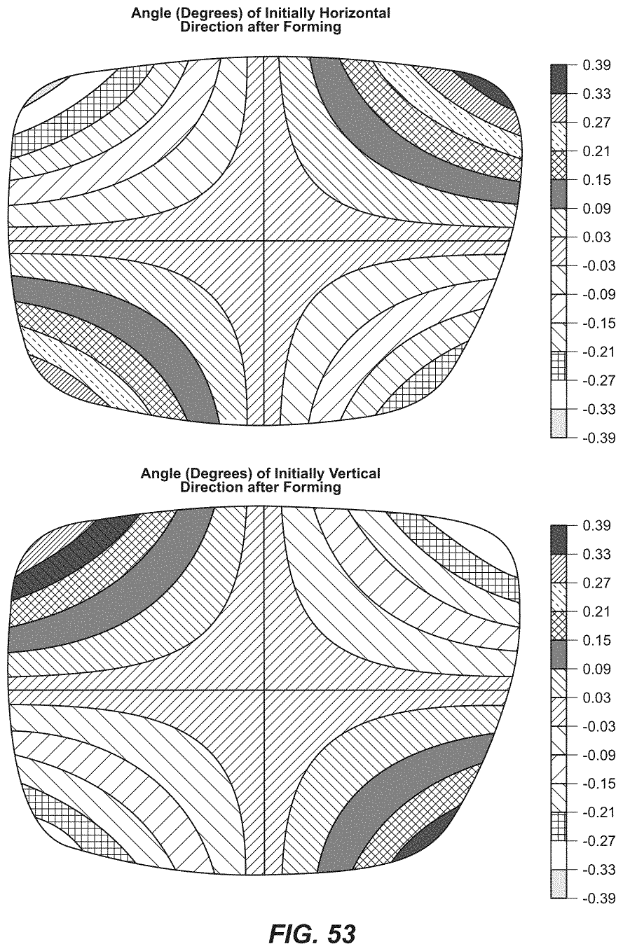

These strain variations may be more suitable for a polymer thin film that is sensitive to strains in the x direction (for example, where voids may result from such strains). In this case, the cylindrical shaped initial film geometry may be more desirable. FIG. 53 shows that for this case, as with most other cases shown here, the material directions that are initially horizontal or vertical do not rotate or distort appreciably due to this forming process.

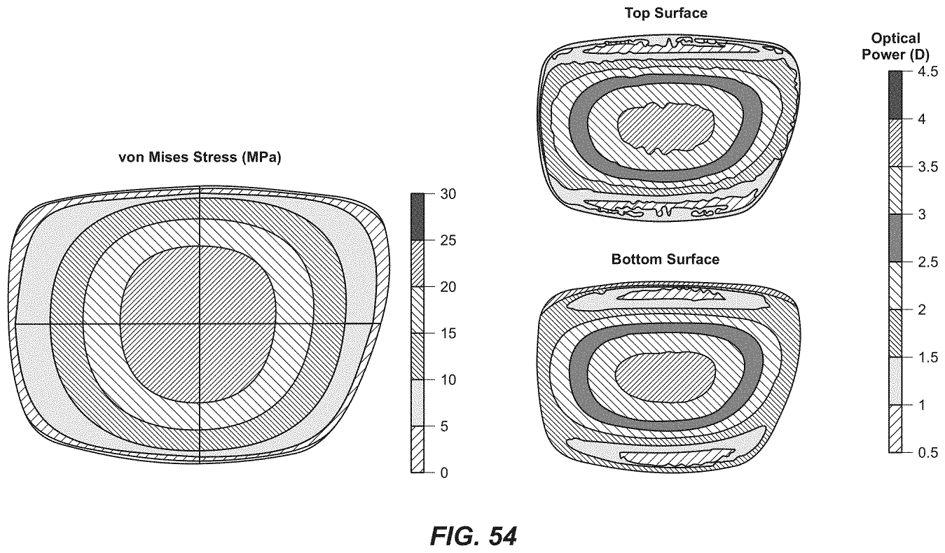

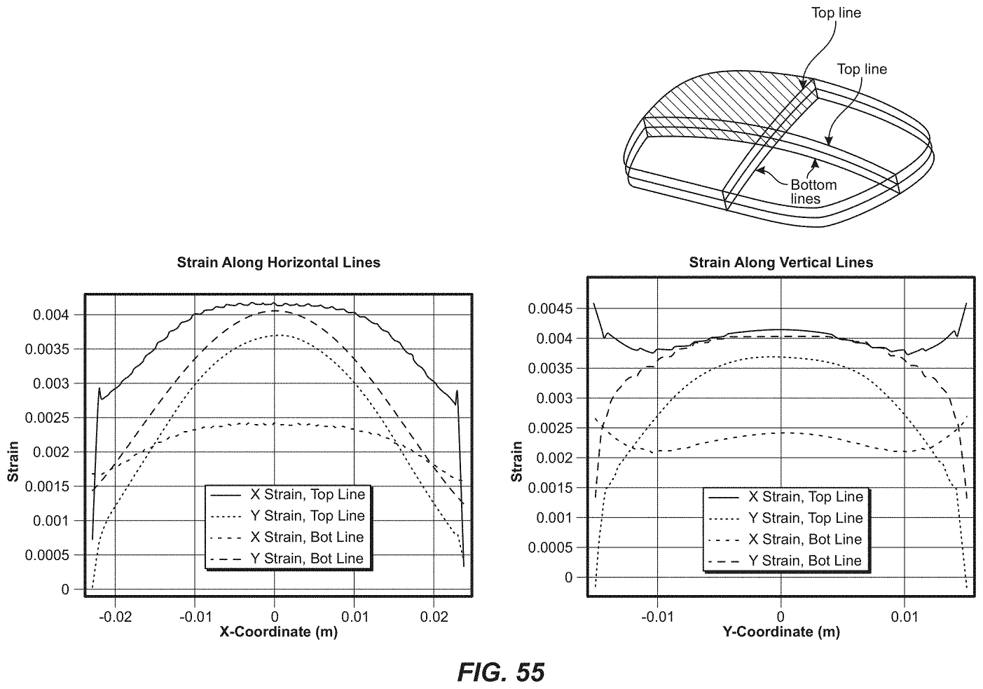

This forming method also works well for other ranges of film stiffness including values between the two film stiffnesses shown earlier. FIG. 54 and FIG. 55 show the same results as the previous example with a 10× stiffer thin film, which has a weak direction stiffness of 200 MPa and a stiff direction stiffness of 5 GPa. FIG. 54 shows the same stress distribution as the 10× softer film, with 10× higher stress values. The compound curvature after forming is very similar to the softer stiffness film. FIG. 55 shows that the strains are of the same order of magnitude as the 10× softer film. The material directions contour plot (not shown) is virtually identical to the 10× softer film.

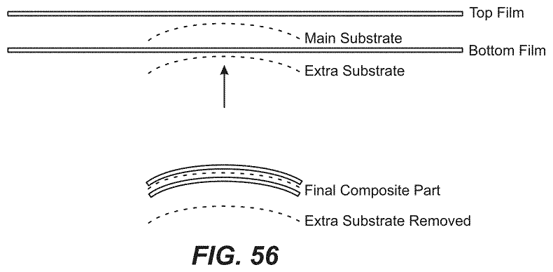

According to further embodiments, a lens can be attached to two films, one on each side. FIG. 56 shows a schematic of how a film can be adhered to the top and bottom surfaces of the lens. This forming method variant may include an additional forming tool behind the second thin film that presses it onto the lens/substrate. Both forming tools may then be removed and the lens shape may be cut out from the circular forming section.

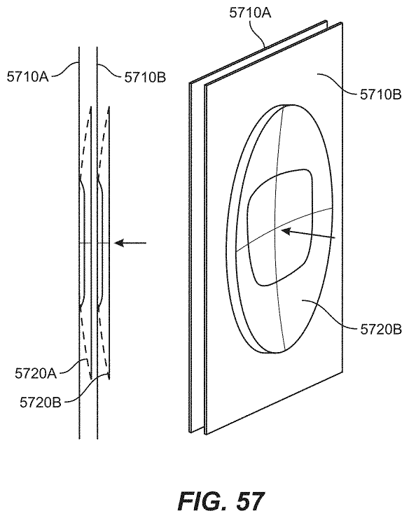

FIG. 57 shows the geometry and forming steps used for one simulation with two films where a main substrate 5720A adheres to a top film 5710A and a bottom film 5710B. The extra/rear substrate 5720B is only used in forming. The films in this example are isotropic, but they may be anisotropic and of different stiffnesses as shown in the previous examples. The top or the bottom film, or both, may be formed into a cylindrical shape. In some embodiments, the radius and film orientation of the top and bottom films are substantially equal.

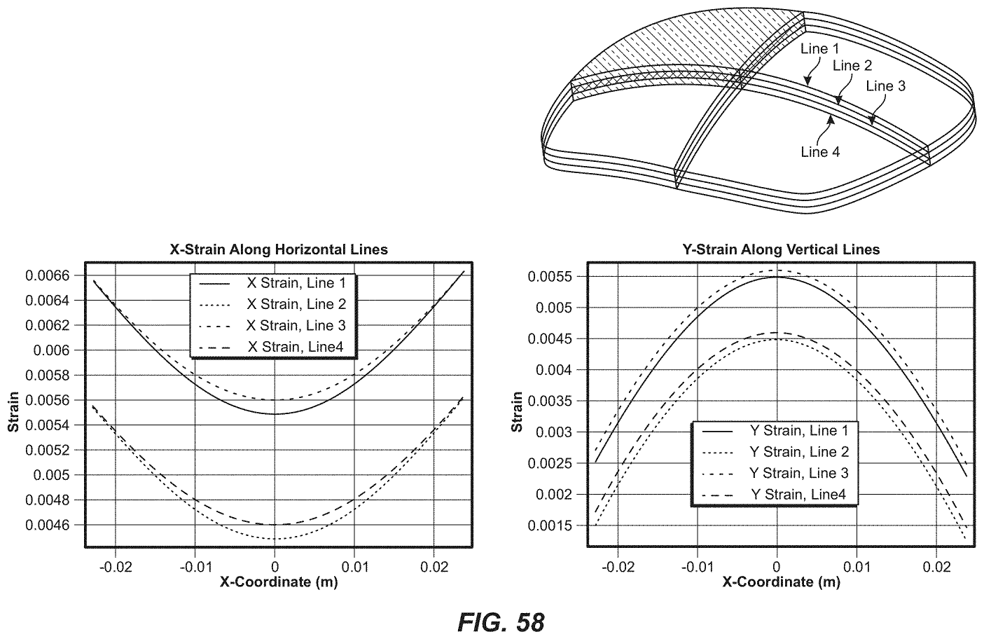

FIG. 58 shows the strains in the x and y directions along 4 horizontal lines immediately following the forming step. Line 1 is located at the top of the top film, Line 2 is located at the bottom of the top film, as in the previous single film cases. Line 3 is located at the top of the bottom film, and Line 4 is located at the bottom of the bottom film. The strains are virtually equivalent in the top and bottom films, and are also virtually the same as in the single film case.

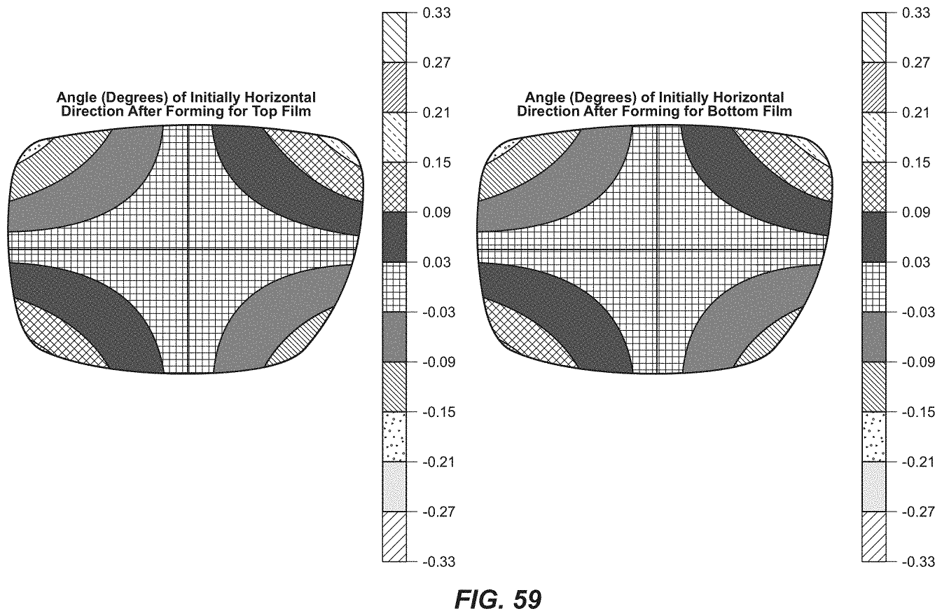

For both the bottom and top films, FIG. 59 shows the angles made with respect to the horizontal and vertical after forming. The angles are small, and are very similar to each other, and are also similar to the angles resulting from the single film case. This example demonstrates that the design variations discussed earlier for the single film case may also apply to cases where two films are applied to the lens, one on each side, using the manufacturing process described herein.

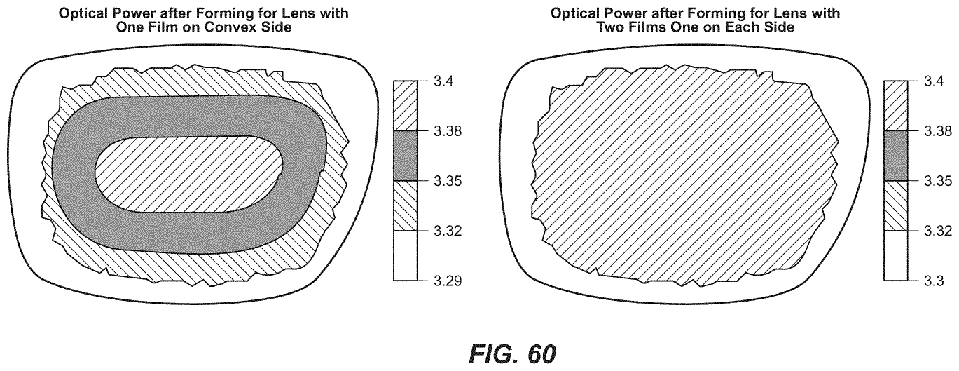

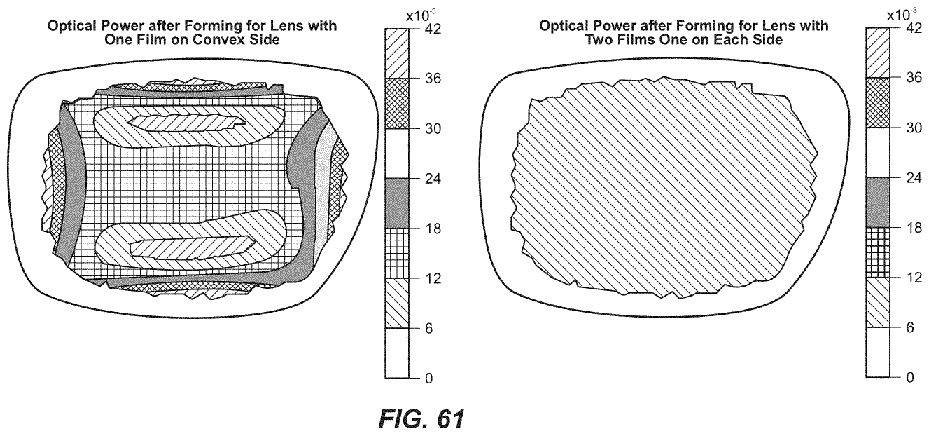

An advantage to forming a polymer thin film over both sides of the lens is that the composite structure may be less likely to distort after removing the forming tools. That is because the biaxial tension present in the films during forming may provide equal and opposite moments that limit the amount of induced distortion. This is evident in FIG. 60, which shows the optical power on one face of a composite lens after releasing from the forming tools. The illustration on the right is for the case with a film on either side of the lens. The illustration on the left is for identical properties and geometry, except that there is only one film on the convex side of the lens, as in most examples described herein. It is evident that the case with two films results in significantly less variation in the optical power. FIG. 61 shows a related plot that shows the cylindricity of the two composite lenses, which is ideally zero in this design since the purpose is to form perfect spherical lenses. The case with films on either side results in much smaller cylindricity values.

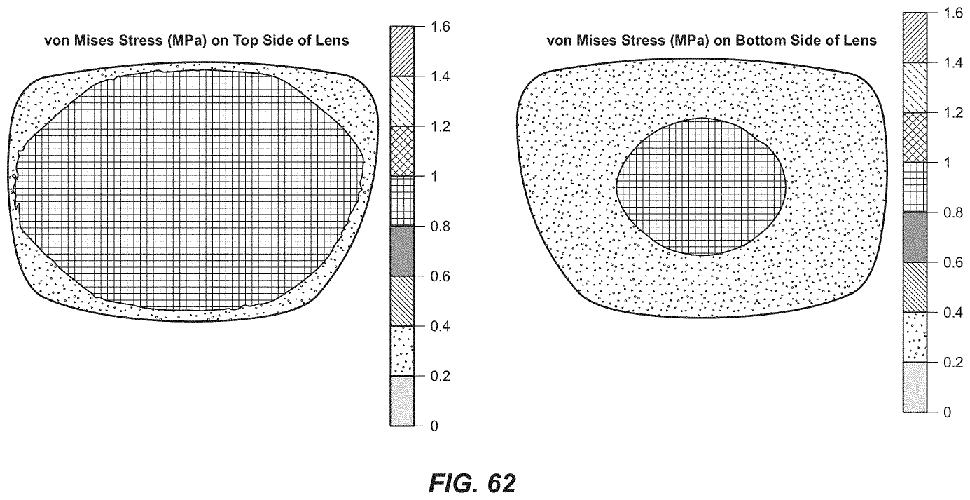

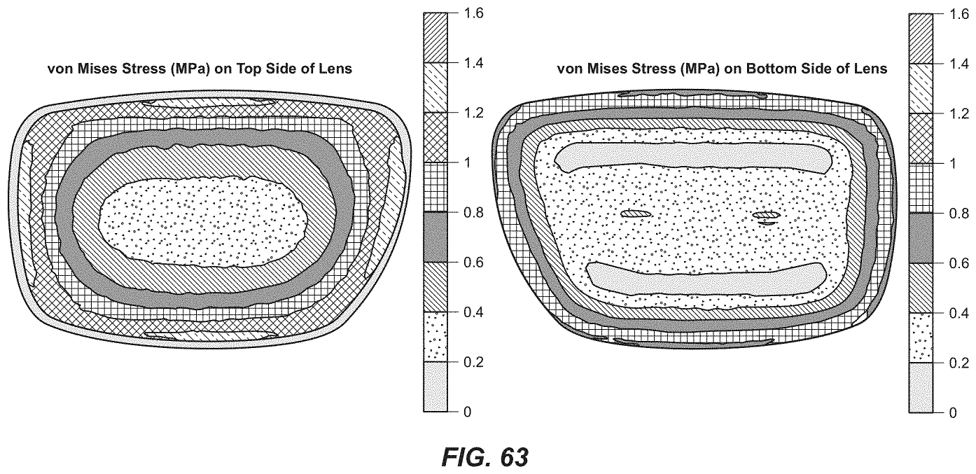

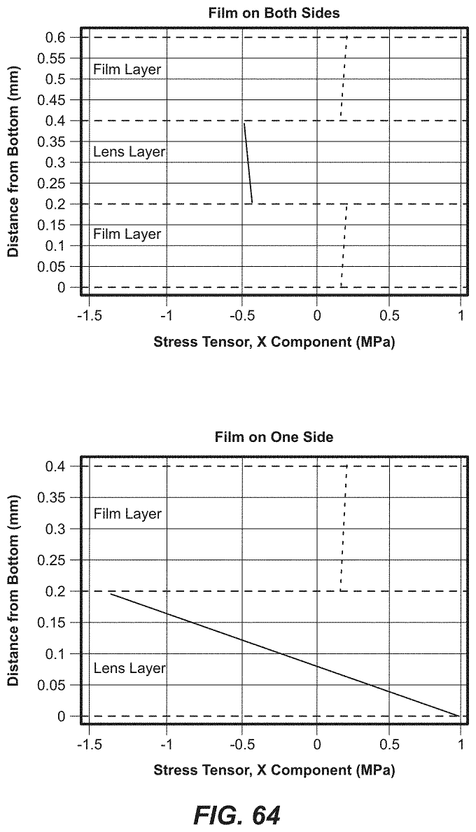

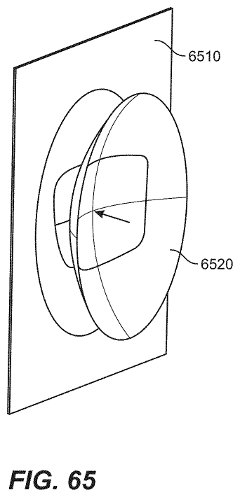

A still further advantage to forming a polymer thin film over both sides of the lens is that it results in lower stresses in the lens. This is evident in FIG. 62, which shows the stresses in the top and bottom of the base lens (not the film) for the same lens/film configuration used above. The stresses do not exceed 0.5 MPa. For comparison, FIG. 63 shows the results with only a single film. The stresses are higher and reach 1.4 MPa. FIG. 64 shows the stresses through the thickness of a composite lens including the film at one point along the lens face. The stresses when there are films on both sides are uniform through the thickness of the lens indicating an in-plane membrane compression stress state in the lens. When the film is on only one side, the stresses vary through its thickness indicating a bending stress state, with higher levels of stress.

In some embodiments, a second film may provide specific optical and/or mechanical properties to the optical element. In some embodiments, the second film may be decrease distortions in the lens after forming, e.g., by balancing the moments the polymer thin films formed over either side of the lens.

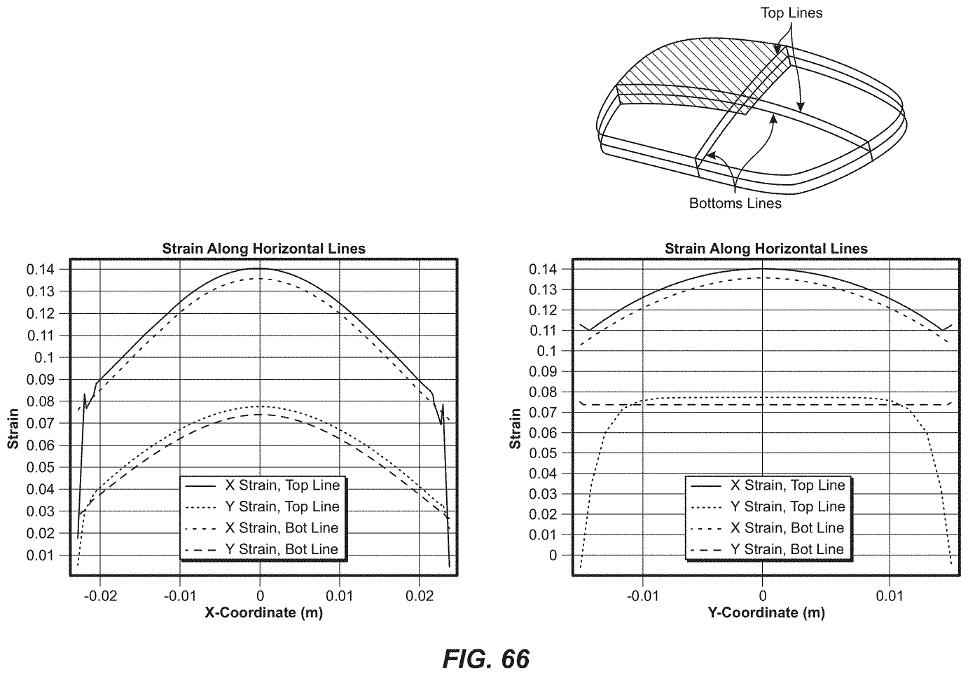

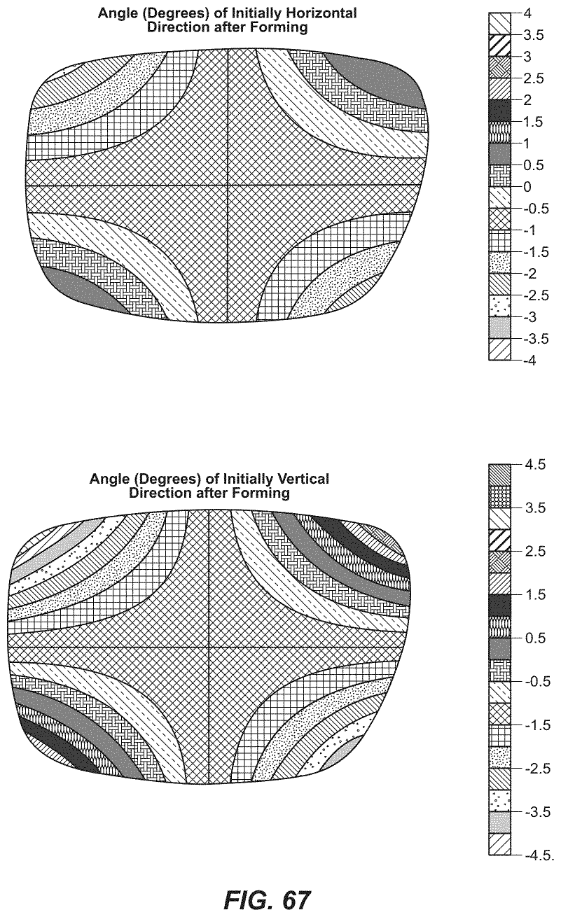

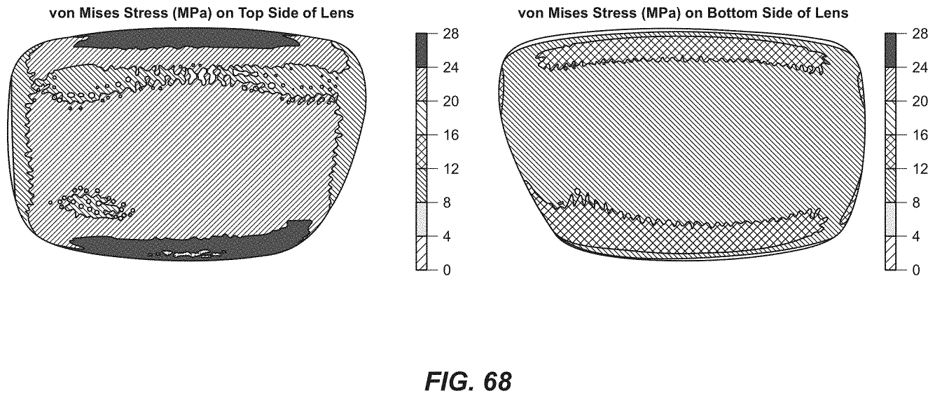

This forming method may also be suitable for cases where the lens has a higher compound curvature (lower radius of curvature). FIG. 65 shows the geometry of a case where an anisotropic polymer thin film 6510 is formed over a substrate 6520 having a constant spherical curvature. The initial radius of curvature of substrate 6520 is only 50 mm (compared to 0.67 m or 0.2 m, in the previous examples). The higher curvature may create higher strains in the polymer thin film, as well as larger angular changes therein. FIG. 66 shows the strains along the horizontal and vertical lines on the lens. The strains are higher than those realized with higher compound curvatures, but still achieve elasticity for many film materials. Referring still to FIG. 66, strains reach 14% in the weak or x direction, and 8% in the stiff or y direction. FIG. 67 shows that the material directions that start out horizontal or vertical rotate or distort by up to 4° in this case. This is much higher than the rotations realized with higher compound curvatures, but is still relatively low, and acceptable for many applications. FIG. 68 shows the von Mises stress on the top and bottom surfaces of the lens (not the film). The stresses reach 24 MPa, which is not high for this lens material having a modulus of 70 GPa. The stresses vary through the thickness indicating that the lens is in a bending stress state.

In this case of 50 mm compound curvature, the composite lens after removal from the forming tool may buckle into a cylindrical shape for the selected lens/film properties and geometry. This buckling may be due to the high initial stresses generated in the film as it is stretched by the forming tool. This buckling may be avoided by using a thicker lens, softer films, thinner films, heat treatment before releasing from the tool, a double sided film to balance the initial stresses, and/or by relocating the clamped film boundaries inward during forming to decrease the initial stresses. Compared with an initially flat polymer thin film, using an initially cylindrical film may result in lower stresses/strains, and the radius of the lens may be tailored to decrease the relevant stress/strain component for a specific application.

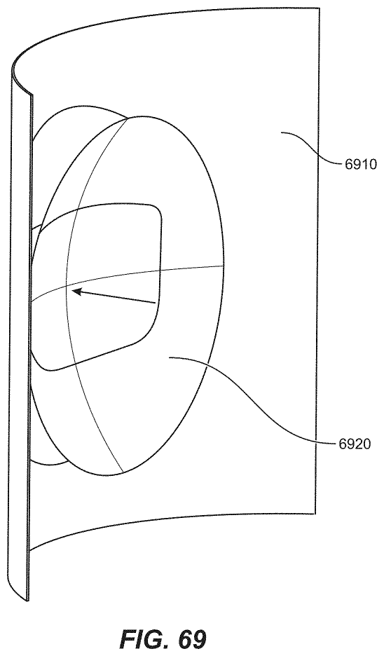

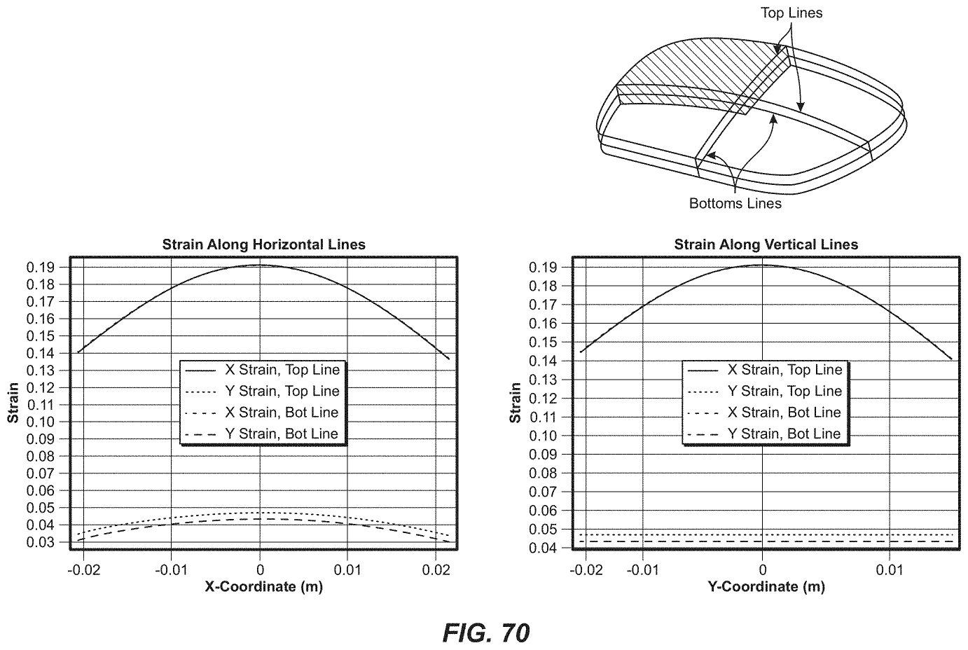

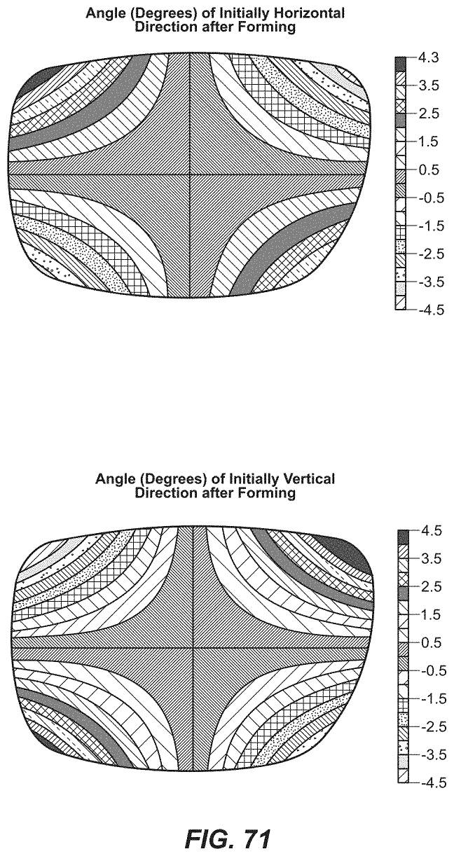

FIG. 69 shows an example where the polymer thin film 6910 has an initially cylindrical shape of radius 60 mm and is formed over a substrate 6920 having a constant spherical curvature. FIG. 70 shows that the strains are higher than the flat film in the x or weak direction, and lower in the y or stiff direction. FIG. 71 shows that the material directions that start out horizontal or vertical rotate or distort by up to 4°, which is similar to the flat film case. As in other examples, such a process may be repeated where successive polymer thin films are stretched over to form previously formed polymer thin film to form a thin film laminate.

Referring again to FIG. 69, in the examples where a thin film laminate is formed from plural polymer thin films, the relative orientation of each of the constituent thin film layers may be determined on a layer-by-layer basis. For example, the cylinder axis of each polymer thin film 6910 may be arranged parallel or perpendicular to the block axis of a reflective polarizer or, in further examples, parallel or perpendicular with respect to a high-modulus axis of a polyethylene or polyvinylidene fluoride multilayer. Such orientational control may be used to configure parallel block axes over a lens or decreased strain and/or haze for polyethylene or polyvinylidene fluoride thin films.

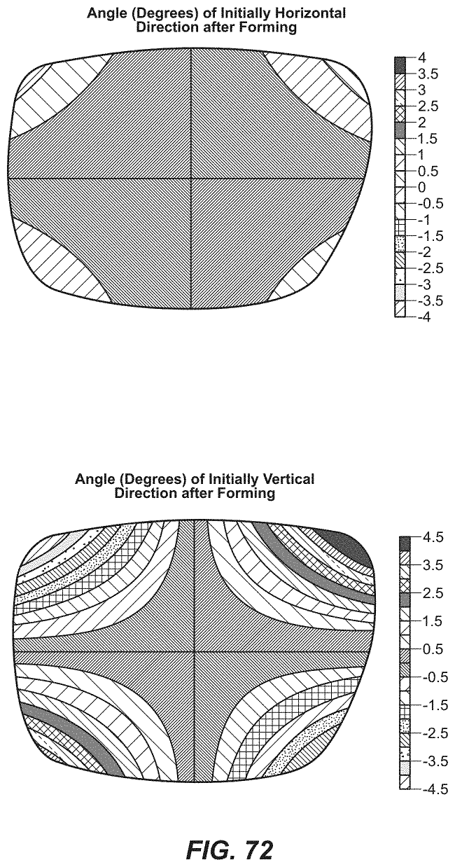

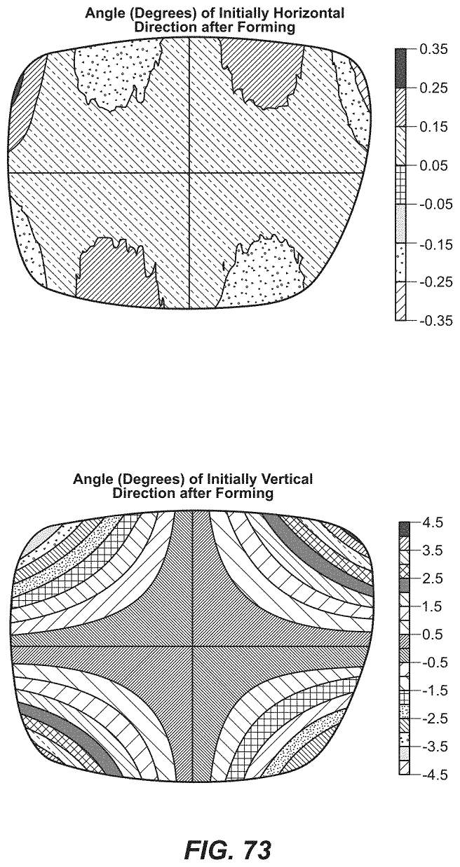

The radius of the initial film cylinder can also be used to limit the maximum change in the material directions. To illustrate this, the initial cylinder radius of curvature in the previous example was changed from 60 mm to 120 mm. FIG. 72 shows that this results in the maximum angle variation in the initially horizontal direction to be only 1.5° instead of 4°. Further adjustments to the initial cylinder radius of curvature can result in decreasing the maximum angle further. This is shown in FIG. 73 where the initial cylinder radius is changed to 180 mm. The maximum angle variation in the initially horizontal direction has dropped to only 0.2° in this case.

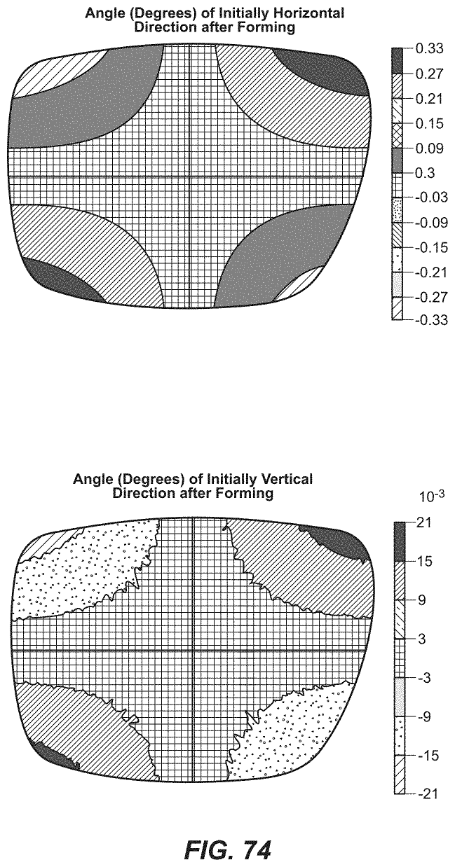

In some embodiments, the rotation of the initially vertical direction of the film may be decreased. This may be done by making the film initially cylindrical with its axis being the horizontal axis, instead of the vertical. This was shown in earlier analyses including the example in FIG. 40. In that example, the lens curvature was 200 mm, and the film initial curvature was 750 mm. The resulting change in material directions is shown in FIG. 44, and shows a maximum angle change of 0.3° for the initially vertical direction. If instead the film has an initial cylindrical radius of 700 mm, the maximum change in the horizontal angle is only approximately 0.02° as shown in FIG. 74. The vertical direction angle is relatively similar to the earlier results from FIG. 44.

In an example multilayer thin film, the individual polymer layers may be anisotropic yet stacked in a related process so as to deliberately misalign the interlayer major and minor axes. That is, the orientation of mutually orthogonal major and minor refractive indices in successive layers of a multilayer stack may be “clocked” at a selected rotational offset. By way of example, and with reference to FIG. 75, the interlayer offset may be 120°, and a multilayer stack (i.e., laminate) 7500 may include a first polymer layer 7510 having a major axis and a minor axis aligned respectively at 0° and 90°, a second polymer layer 7520 overlying the first polymer layer having a major axis and a minor axis aligned respectively at 120° and 210°, and a third polymer layer 7530 overlying the second polymer layer having a major axis and a minor axis aligned respectively at 240° and 330°.

A variable forming process can be used to form uniform stresses or strains in one direction versus another, lower stresses or strains in one direction versus another, or decrease angular distortion in one direction versus another. For example, if strains in the weak direction of the film are critical for failure, the forming process can target lower strains in the weak direction. Process variables may include one or more of (a) adding a “skirt” around a lens shaped substrate during forming to achieve lower or more uniform stresses/strains, (b) using an initially cylindrically shaped film instead of a flat film to achieve lower or more uniform stresses/strains, (c) using a circular instead of a square flat film to achieve more uniform stresses/strains, (d) inducing movement of the fixed edges of the film during the forming process to decrease the forming stresses/strains, and (e) applying a heat treatment to the film before releasing the forming tool.

As disclosed herein, an anisotropic polymer thin film may be formed to a compound curvature in such a manner as to inhibit or prevent unintended artifacts associated with the creation of complex stress and strain states that accompany the deformation of the thin film. In various applications, an anisotropic thin film may be laminated to the surface of a lens or other non-planar substrate to form an optical element. In connection with such a process, it may be desirable to avoid a local change in the properties of the thin film resulting from its change in shape. An anisotropic polymer thin film may exhibit acceptable stress and strain uniformity throughout an entire surface of the polymer thin film throughout a process of forming the polymer thin film.

In the example of a reflective polarizer, it may be advantageous to avoid locally altering the film's principal axis associated with its block state, and thereby evade a decrease in contrast ratio and/or the formation of ghost images. With regard to the mechanical anisotropy indigenous to polymer thin films such as polyethylene and polyvinylidene fluoride, uncontrolled stretching may induce fracture of crystalline moieties within the thin film along its mechanically weak direction, which may create nanovoids that create haze in the optical element. In view of the foregoing, and in accordance with various embodiments, an anisotropic polymer thin film may be initially provided with simple (e.g., cylindrical) curvature, which beneficially impacts the film's response to the formation of compound curvature during lamination to a substrate having complex curvature.

In the context of a reflective polarizer, the cylinder axis may be oriented parallel to the polarization axis of the polymer thin film. On the other hand, to decrease strains that may lead to nanovoiding, the cylinder axis may be oriented along the mechanically weak direction of the polymer thin film.

According to further embodiments, edge effects in an optical element may be decreased or eliminated by artificially extending the surface of a lens at its periphery during the process of over-forming the polymer thin film by using a skirt that effectively moves the discontinuity associated with an edge away from the edge of the lens.

### Example Embodiments

Example 1: An anisotropic polymer thin film is characterized by compound curvature, where a maximum variation of an angle of orientation of an extraordinary axis of the polymer thin film is at most 2% greater than an orientation variation associated with an initially planar polymer thin film formed to the compound curvature.

Example 2: The anisotropic polymer thin film according to Example 1, where the compound curvature includes a radius of curvature of less than approximately 1 m.

Example 3: The anisotropic polymer thin film according to any of Examples 1 and 2, where the compound curvature is characterized by a spatially varying curvature selected from a uniform spherical compound curvature, and a combination of spherical and cylindrical curvatures.

Example 4: The anisotropic polymer thin film according to any of Examples 1-3, where the maximum variation of the angle of orientation does not exceed 2% through a process of forming the anisotropic polymer thin film.

Example 5: The anisotropic polymer thin film according to any of Examples 1-4, where the polymer includes polyethylene having an extraordinary modulus of at least approximately 5 GPa.

Example 6: The anisotropic polymer thin film according to any of Examples 1-4, where the polymer includes polyvinylidene fluoride having an extraordinary piezoelectric coefficient (d₃₁) of at least approximately 10 pC/N.

Example 7: The anisotropic polymer thin film according to any of Examples 1-6, where the polymer thin film is optically transparent.

Example 8: The anisotropic polymer thin film according to any of Examples 1-7, where the polymer thin film is characterized by a bulk haze of less than approximately 10%.

Example 9: A multilayer polymer thin film includes a first anisotropic polymer thin film having compound curvature and a second anisotropic polymer thin film having compound curvature bonded to the first anisotropic polymer thin film.

Example 10: The multilayer polymer thin film according to Example 9, where an orientation of the first anisotropic polymer thin film is rotationally offset from an orientation of the second anisotropic polymer thin film.

Example 11: The multilayer polymer thin film according to any of Examples 9 and 10, where the compound curvature includes a radius of curvature of less than approximately 1 m.

Example 12: The multilayer polymer thin film according to any of Examples 9-11, where the polymer thin film includes polyethylene having an extraordinary modulus of at least approximately 5 GPa.

Example 13: The multilayer polymer thin film according to any of Examples 9-11, where the polymer thin film includes polyvinylidene fluoride having an extraordinary piezoelectric coefficient (d₃₁) of at least 10 approximately pC/N.

Example 14: The multilayer polymer thin film according to any of Examples 9-13, where the polymer thin film is optically transparent.

Example 15: A method includes providing an anisotropic polymer thin film, constraining the thin film so as to create a contour in the thin film, and contacting a templating element having compound curvature with a surface of the polymer thin film to induce the compound curvature into the surface.

Example 16: The method according to Example 15, where the polymer thin film is optically or mechanically anisotropic.

Example 17: The method according to any of Examples 15 and 16, where the contour is planar.

Example 18: The method according to any of Examples 15 and 16, where the contour is non-planar.

Example 19: The method according to any of Examples 15-18, where the templating element includes a lens.

Example 20: The method according to any of Examples 15-19, where the compound curvature of the templating element has an extended form factor relative to the surface of the polymer thin film.

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

Artificial-reality systems may be implemented in a variety of different form factors and configurations. Some artificial-reality systems may be designed to work without near-eye displays (NEDs). Other artificial-reality systems may include an NED that also provides visibility into the real world (such as, e.g., augmented-reality system 7600 in FIG. 76) or that visually immerses a user in an artificial reality (such as, e.g., virtual-reality system 7700 in FIG. 77). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 76, augmented-reality system 7600 may include an eyewear device 7602 with a frame 7610 configured to hold a left display device 7615(A) and a right display device 7615(B) in front of a user's eyes. Display devices 7615(A) and 7615(B) may act together or independently to present an image or series of images to a user. While augmented-reality system 7600 includes two displays, embodiments of this disclosure may be implemented in augmented-reality systems with a single NED or more than two NEDs.

In some embodiments, augmented-reality system 7600 may include one or more sensors, such as sensor 7640. Sensor 7640 may generate measurement signals in response to motion of augmented-reality system 7600 and may be located on substantially any portion of frame 7610. Sensor 7640 may represent one or more of a variety of different sensing mechanisms, such as a position sensor, an inertial measurement unit (IMU), a depth camera assembly, a structured light emitter and/or detector, or any combination thereof. In some embodiments, augmented-reality system 7600 may or may not include sensor 7640 or may include more than one sensor. In embodiments in which sensor 7640 includes an IMU, the IMU may generate calibration data based on measurement signals from sensor 7640. Examples of sensor 7640 may include, without limitation, accelerometers, gyroscopes, magnetometers, other suitable types of sensors that detect motion, sensors used for error correction of the IMU, or some combination thereof.

In some examples, augmented-reality system 7600 may also include a microphone array with a plurality of acoustic transducers 7620(A)-7620(J), referred to collectively as acoustic transducers 7620. Acoustic transducers 7620 may represent transducers that detect air pressure variations induced by sound waves. Each acoustic transducer 7620 may be configured to detect sound and convert the detected sound into an electronic format (e.g., an analog or digital format). The microphone array in FIG. 76 may include, for example, ten acoustic transducers: 7620(A) and 7620(B), which may be designed to be placed inside a corresponding ear of the user, acoustic transducers 7620(C), 7620(D), 7620(E), 7620(F), 7620(G), and 7620(H), which may be positioned at various locations on frame 7610, and/or acoustic transducers 7620(I) and 7620(J), which may be positioned on a corresponding neckband 7605.

In some embodiments, one or more of acoustic transducers 7620(A)-(J) may be used as output transducers (e.g., speakers). For example, acoustic transducers 7620(A) and/or 7620(B) may be earbuds or any other suitable type of headphone or speaker.

The configuration of acoustic transducers 7620 of the microphone array may vary. While augmented-reality system 7600 is shown in FIG. 76 as having ten acoustic transducers 7620, the number of acoustic transducers 7620 may be greater or less than ten. In some embodiments, using higher numbers of acoustic transducers 7620 may increase the amount of audio information collected and/or the sensitivity and accuracy of the audio information. In contrast, using a lower number of acoustic transducers 7620 may decrease the computing power required by an associated controller 7650 to process the collected audio information. In addition, the position of each acoustic transducer 7620 of the microphone array may vary. For example, the position of an acoustic transducer 7620 may include a defined position on the user, a defined coordinate on frame 7610, an orientation associated with each acoustic transducer 7620, or some combination thereof.

Acoustic transducers 7620(A) and 7620(B) may be positioned on different parts of the user's ear, such as behind the pinna, behind the tragus, and/or within the auricle or fossa. Or, there may be additional acoustic transducers 7620 on or surrounding the ear in addition to acoustic transducers 7620 inside the ear canal. Having an acoustic transducer 7620 positioned next to an ear canal of a user may enable the microphone array to collect information on how sounds arrive at the ear canal. By positioning at least two of acoustic transducers 7620 on either side of a user's head (e.g., as binaural microphones), augmented-reality device 7600 may simulate binaural hearing and capture a 3D stereo sound field around about a user's head. In some embodiments, acoustic transducers 7620(A) and 7620(B) may be connected to augmented-reality system 7600 via a wired connection 7630, and in other embodiments acoustic transducers 7620(A) and 7620(B) may be connected to augmented-reality system 7600 via a wireless connection (e.g., a BLUETOOTH connection). In still other embodiments, acoustic transducers 7620(A) and 7620(B) may not be used at all in conjunction with augmented-reality system 7600.

Acoustic transducers 7620 on frame 7610 may be positioned in a variety of different ways, including along the length of the temples, across the bridge, above or below display devices 7615(A) and 7615(B), or some combination thereof. Acoustic transducers 7620 may also be oriented such that the microphone array is able to detect sounds in a wide range of directions surrounding the user wearing the augmented-reality system 7600. In some embodiments, an optimization process may be performed during manufacturing of augmented-reality system 7600 to determine relative positioning of each acoustic transducer 7620 in the microphone array.

In some examples, augmented-reality system 7600 may include or be connected to an external device (e.g., a paired device), such as neckband 7605. Neckband 7605 generally represents any type or form of paired device. Thus, the following discussion of neckband 7605 may also apply to various other paired devices, such as charging cases, smart watches, smart phones, wrist bands, other wearable devices, hand-held controllers, tablet computers, laptop computers, other external compute devices, etc.

As shown, neckband 7605 may be coupled to eyewear device 7602 via one or more connectors. The connectors may be wired or wireless and may include electrical and/or non-electrical (e.g., structural) components. In some cases, eyewear device 7602 and neckband 7605 may operate independently without any wired or wireless connection between them. While FIG. 76 illustrates the components of eyewear device 7602 and neckband 7605 in example locations on eyewear device 7602 and neckband 7605, the components may be located elsewhere and/or distributed differently on eyewear device 7602 and/or neckband 7605. In some embodiments, the components of eyewear device 7602 and neckband 7605 may be located on one or more additional peripheral devices paired with eyewear device 7602, neckband 7605, or some combination thereof.

Pairing external devices, such as neckband 7605, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 7600 may be provided by a paired device or shared between a paired device and an eyewear device, thus reducing the weight, heat profile, and form factor of the eyewear device overall while still retaining desired functionality. For example, neckband 7605 may allow components that would otherwise be included on an eyewear device to be included in neckband 7605 since users may tolerate a heavier weight load on their shoulders than they would tolerate on their heads. Neckband 7605 may also have a larger surface area over which to diffuse and disperse heat to the ambient environment. Thus, neckband 7605 may allow for greater battery and computation capacity than might otherwise have been possible on a stand-alone eyewear device. Since weight carried in neckband 7605 may be less invasive to a user than weight carried in eyewear device 7602, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 7605 may be communicatively coupled with eyewear device 7602 and/or to other devices. These other devices may provide certain functions (e.g., tracking, localizing, depth mapping, processing, storage, etc.) to augmented-reality system 7600. In the embodiment of FIG. 76, neckband 7605 may include two acoustic transducers (e.g., 7620(I) and 7620(J)) that are part of the microphone array (or potentially form their own microphone subarray). Neckband 7605 may also include a controller 7625 and a power source 7635.

Acoustic transducers 7620(I) and 7620(J) of neckband 7605 may be configured to detect sound and convert the detected sound into an electronic format (analog or digital). In the embodiment of FIG. 76, acoustic transducers 7620(I) and 7620(J) may be positioned on neckband 7605, thereby increasing the distance between the neckband acoustic transducers 7620(I) and 7620(J) and other acoustic transducers 7620 positioned on eyewear device 7602. In some cases, increasing the distance between acoustic transducers 7620 of the microphone array may improve the accuracy of beamforming performed via the microphone array. For example, if a sound is detected by acoustic transducers 7620(C) and 7620(D) and the distance between acoustic transducers 7620(C) and 7620(D) is greater than, e.g., the distance between acoustic transducers 7620(D) and 7620(E), the determined source location of the detected sound may be more accurate than if the sound had been detected by acoustic transducers 7620(D) and 7620(E).

Controller 7625 of neckband 7605 may process information generated by the sensors on neckband 7605 and/or augmented-reality system 7600. For example, controller 7625 may process information from the microphone array that describes sounds detected by the microphone array. For each detected sound, controller 7625 may perform a direction-of-arrival (DOA) estimation to estimate a direction from which the detected sound arrived at the microphone array. As the microphone array detects sounds, controller 7625 may populate an audio data set with the information. In embodiments in which augmented-reality system 7600 includes an inertial measurement unit, controller 7625 may compute all inertial and spatial calculations from the IMU located on eyewear device 7602. A connector may convey information between augmented-reality system 7600 and neckband 7605 and between augmented-reality system 7600 and controller 7625. The information may be in the form of optical data, electrical data, wireless data, or any other transmittable data form. Moving the processing of information generated by augmented-reality system 7600 to neckband 7605 may reduce weight and heat in eyewear device 7602, making it more comfortable to the user.

Power source 7635 in neckband 7605 may provide power to eyewear device 7602 and/or to neckband 7605. Power source 7635 may include, without limitation, lithium ion batteries, lithium-polymer batteries, primary lithium batteries, alkaline batteries, or any other form of power storage. In some cases, power source 7635 may be a wired power source. Including power source 7635 on neckband 7605 instead of on eyewear device 7602 may help better distribute the weight and heat generated by power source 7635.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 7700 in FIG. 77, that mostly or completely covers a user's field of view. Virtual-reality system 7700 may include a front rigid body 7702 and a band 7704 shaped to fit around a user's head. Virtual-reality system 7700 may also include output audio transducers 7706(A) and 7706(B). Furthermore, while not shown in FIG. 77, front rigid body 7702 may include one or more electronic elements, including one or more electronic displays, one or more inertial measurement units (IMUS), one or more tracking emitters or detectors, and/or any other suitable device or system for creating an artificial-reality experience.

Artificial-reality systems may include a variety of types of visual feedback mechanisms. For example, display devices in augmented-reality system 7600 and/or virtual-reality system 7700 may include one or more liquid crystal displays (LCDs), light emitting diode (LED) displays, microLED displays, organic LED (OLED) displays, digital light project (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., conventional concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in augmented-reality system 7600 and/or virtual-reality system 7700 may include microLED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, augmented-reality system 7600 and/or virtual-reality system 7700 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

It will be understood that when an element such as a layer or a region is referred to as being formed on, deposited on, or disposed “on,” “over,” or “overlying” another element, it may be located directly on at least a portion of the other element, or one or more intervening elements may also be present. In contrast, when an element is referred to as being “directly on,” “directly over,” or “directly overlying” another element, it may be located on at least a portion of the other element, with no intervening elements present.

As used herein, the term “substantially” in reference to a given parameter, property, or condition may mean and include to a degree that one of ordinary skill in the art would understand that the given parameter, property, or condition is met with a small degree of variance, such as within acceptable manufacturing tolerances. By way of example, depending on the particular parameter, property, or condition that is substantially met, the parameter, property, or condition may be at least approximately 90% met, at least approximately 95% met, or even at least approximately 99% met.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to an optical element that comprises or includes ultra-high molecular weight polyethylene include embodiments where an optical element consists of ultra-high molecular weight polyethylene and embodiments where an optical element consists essentially of ultra-high molecular weight polyethylene.

What is claimed is:

1. An anisotropic polymer thin film comprising compound curvature, wherein a maximum variation of an angle of orientation of an extraordinary axis of the polymer thin film is at most 2% greater than an orientation variation associated with an initially planar polymer thin film formed to the compound curvature.

2. The anisotropic polymer thin film of claim 1, wherein the compound curvature comprises a radius of curvature of less than approximately 1 m.

3. The anisotropic polymer thin film of claim 1, wherein the compound curvature is characterized by a spatially varying curvature selected from the group consisting of a uniform spherical compound curvature, and a combination of spherical and cylindrical curvatures.

4. The anisotropic polymer thin film of claim 1, wherein the maximum variation of the angle of orientation does not exceed 2% through a process of forming the anisotropic polymer thin film.

5. The anisotropic polymer thin film of claim 1, comprising polyethylene having an extraordinary modulus of at least approximately 5 GPa.

6. The anisotropic polymer thin film of claim 1, comprising polyvinylidene fluoride having an extraordinary piezoelectric coefficient (d₃₁) of at least approximately 10 pC/N.

7. The anisotropic polymer thin film of claim 1, wherein the polymer thin film is optically transparent.

8. The anisotropic polymer thin film of claim 1, wherein the polymer thin film is characterized by a bulk haze of less than approximately 10%.

9. A multilayer polymer thin film comprising:
a first anisotropic polymer thin film having compound curvature; and
a second anisotropic polymer thin film having compound curvature bonded to the first anisotropic polymer thin film.

10. The multilayer polymer thin film of claim 9, wherein an orientation of the first anisotropic polymer thin film is rotationally offset from an orientation of the second anisotropic polymer thin film.

11. The multilayer polymer thin film of claim 9, wherein the compound curvature comprises a radius of curvature of less than approximately 1 m.

12. The multilayer polymer thin film of claim 9, wherein the polymer thin film comprises polyethylene having an extraordinary modulus of at least approximately 5 GPa.

13. The multilayer polymer thin film of claim 9, wherein the polymer thin film comprises polyvinylidene fluoride having an extraordinary piezoelectric coefficient (d₃₁) of at least 10 approximately pC/N.

14. The multilayer polymer thin film of claim 9, wherein the polymer thin film is optically transparent.

15. A method comprising:
providing an anisotropic polymer thin film;
constraining the thin film so as to create a contour in the thin film; and
contacting a templating element having compound curvature with a surface of the polymer thin film to induce the compound curvature into the surface.

16. The method of claim 15, wherein the polymer thin film is optically anisotropic or mechanically anisotropic.

17. The method of claim 15, wherein the contour is planar.

18. The method of claim 15, wherein the contour is non-planar.

19. The method of claim 15, wherein the templating element comprises a lens.

20. The method of claim 15, wherein the compound curvature of the templating element has an extended form factor relative to the surface of the polymer thin film.
